(19) United States
(12) Patent Application Publication
(10) Pub. No.: US 2019/0109768 A1
(43) Pub. Date: Apr. 11, 2019

(54) MANAGEMENT OF NETWORK SLICES AND ASSOCIATED SERVICES

(71) Applicants: Nimal Gamini SENARATH, Ottawa (CA); Chengchao LIANG, Ottawa (CA); Hang ZHANG, Nepean (CA); Remziye Irem BOR-YALINIZ, Ottawa (CA)

(72) Inventors: Nimal Gamini SENARATH, Ottawa (CA); Chengchao LIANG, Ottawa (CA); Hang ZHANG, Nepean (CA); Remziye Irem BOR-YALINIZ, Ottawa (CA)

(73) Assignee: HUAWEI TECHNOLOGIES CO., LTD., SHENZHEN (CN)

(21) Appl. No.: 16/146,345

(22) Filed: Sep. 28, 2018

Related U.S. Application Data
(60) Provisional application No. 62/569,018, filed on Oct. 6, 2017.

(51) Int. Cl. H04L 12/24; G06F 9/455; H04W 28/24; H04W 48/18

(52) U.S. Cl. CPC H04L 41/0896; H04L 41/5006; H04L 41/0681; H04L 41/0286; G06F 2009/45595; G06F 9/45558; H04W 28/24; H04W 48/18; H04L 41/5051

(57) ABSTRACT

A network management system configured to: selectively expose network management data; receive a request for a network service, the request including service requirements and parameters in accordance with the exposed network management data, wherein the service comprises a selected one of: Communication as a Service (CaaS), Network Slice as a Service (NSaaS), Network Slice Subnet as a Service (NSSaaS), and Infrastructure as a Service (IaaS); and responsive to the received request, negotiate a service level agreement based on the service requirements and parameters.

### CROSS-REFERENCE TO RELATED APPLICATIONS

This application claims the benefit of U.S. Provisional Application Ser. No. 62/569,018 titled “MANAGEMENT OF NETWORK SLICES AND ASSOCIATED SERVICES” filed on Oct. 6, 2017 which is incorporated by reference herein in its entirety.

### FIELD OF THE INVENTION

The present invention pertains to the field of communications networks, and in particular to management of network slices and associated services.

### SUMMARY

An object of embodiments of the present invention is to provide techniques for management of network slices and associated services.

Aspects of the disclosure provide methods and systems that allow for different types of service providers to provide different types of services. Further such techniques allow the different service providers to utilize different levels of control over the resources that provide the services. Different levels of exposure of the management capabilities (including the resources, capabilities, and capacities) allows for different levels of service request details and corresponding levels of control of how the management capabilities are utilized to provide services specified in the request.

In some embodiments a request has a specification detail corresponding to a network exposure type previously provided by the network provider. For example, there are several exposure types (A-D, E1 and E2) each with a different level of specificity as the management capabilities, resources and capacity. Accordingly, the request can have corresponding levels of specificity as to how to implement the request, from an intent based request as to the intent desired, to specific details of how to allocate previously exposed resources to deliver a requested service.

Each exposure type includes a corresponding level of detail that can be provided in the request from a requesting customer. Accordingly, each exposure type allows for more detailed requests, allowing for more detailed control by the requester of the resources provided by the provider. From exposure type A1 to E2, the network management evolves from fully intent-driven to a less intent-driven fashion. In some embodiments a Service Management Exposure Function (SMEF) provides exposure interfaces for data and/or management exposure. It is the enabler to have different exposure levels without complicating individual network functions, such as NSMF, CSMF. An exposure level can be provided to SMEF as an “intent”, and SMEF can arrange the network to respond to this intent/request.

An aspect of the disclosure provides a method of delivering a communication service. Such a method includes receiving, by a network management system, a request from a requestor for a service. The method further includes requesting, by the network management system, resources to satisfy the request. Such a method further includes receiving, by the network management system, information about the resources, and providing the service utilizing the resources. An aspect of the disclosure provides a network management system configured to: selectively expose network management data; receive a request for a network service, the request including service requirements and parameters in accordance with the exposed network management data and/or capability via an exposure function, wherein the service comprises a selected one of: Communication as a Service (CaaS), Network Slice as a Service (NSaaS), Network Slice Subnet as a Service (NSSaaS), and Infrastructure as a Service (IaaS); and responsive to the received request, negotiate a service level agreement based on the service requirements and parameters.

### BRIEF DESCRIPTION OF THE FIGURES

Further features and advantages of the present invention will become apparent from the following detailed description, taken in combination with the appended drawings, in which:

FIG. 1 is a block diagram of an electronic device within a computing and communications environment that may be used for implementing devices and methods in accordance with representative embodiments of the present invention;

FIG. 2 is a block diagram illustrating a logical platform under which an Electronic Device can provide virtualization services;

FIG. 3A is a block diagram schematically illustrating an example architecture in which network slicing can be implemented;

FIG. 3B is a block diagram illustrating the architecture discussed in FIG. 3A from the perspective of a single slice;

FIG. 4 is a block diagram illustrating an example ETSI NFV MANO compliant management and orchestration service;

FIGS. 5A-5D are block diagrams illustrating example network management function deployments for four types of telecommunication services; FIG. 5a illustrates providing a CSI as a service (CaaS); FIG. 5B illustrates providing an Network Slice Instance (NSI) as a service (NSaaS); FIG. 5C illustrates providing a Network Slice Subnet Instance (NSSI) as a service (NSSaaS); and FIG. 5D illustrates providing Infrastructure as a service (IaaS);

FIG. 6 is a block diagram illustrating an example deployment of management functions in providing a CSI as a service (CaaS), and pairs with FIG. 5A;

FIG. 7 is a block diagram illustrating an example deployment of management functions in providing an NSI as a service (NSaaS), and pairs with FIG. 5B;

FIG. 8 is a block diagram illustrating an example deployment of management functions in providing a NSSI as a service (NSSaaS), and pairs with FIG. 5C;

FIG. 9 is a block diagram illustrating an example deployment of management functions in providing Infrastructure as a service (IaaS), and pairs with FIG. 5D;

FIG. 10, divided into FIG. 10A and FIG. 10B, is a call-flow diagram illustrating an example process for negotiating a CaaS for Exposure type A;

FIG. 11 is a call-flow diagram illustrating an example process for negotiating a CaaS for Exposure types B-D;

FIG. 12 is a call-flow diagram illustrating an example process for deploying a CSI on a new slice with type A1 exposure to customer;

FIG. 13, divided into FIG. 13A and FIG. 13B, is a call-flow diagram illustrating an example process for Service modification request negotiation for exposure types A-D; and

FIG. 14 is a call flow diagram illustrating an example of performing an accepted service modification request for exposure types A-D;

It will be noted that throughout the appended drawings, like features are identified by like reference numerals.

### DETAILED DESCRIPTION

In the following description, features of the present invention are described by way of example embodiments. For convenience of description, these embodiments make use of features and terminology known from 4G and 5G networks as defined by the Third Generation Partnership Project (3GPP). However, it shall be understood that the present invention is not limited to such networks. Rather, methods and systems in accordance with the present invention may be implemented in any network in which a mobile device may connect to the network through at least one access point, and subsequently be handed-over to at least one other access point during the course of a communications session.

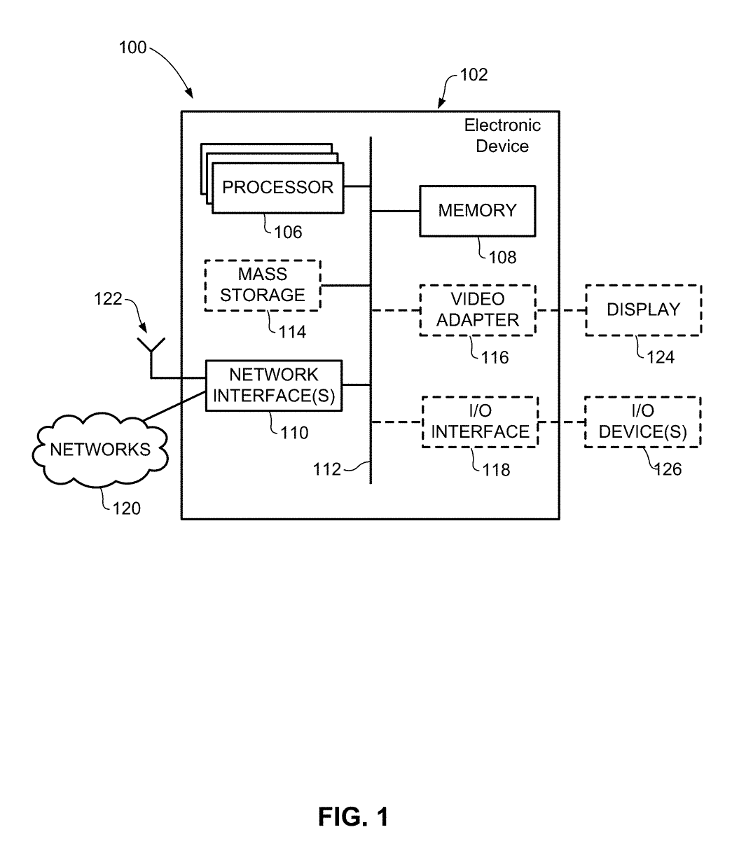

FIG. 1 is a block diagram of an electronic device (ED) 102 illustrated within a computing and communications environment 100 that may be used for implementing the devices and methods disclosed herein. In some embodiments, the electronic device 102 may be an element of communications network infrastructure, such as a base station (for example a NodeB, an enhanced Node B (eNodeB), a next generation NodeB (sometimes referred to as a gNodeB or gNB), a home subscriber server (HSS), a gateway (GW) such as a packet gateway (PGW) or a serving gateway (SGW) or various other nodes or functions within an evolved packet core (EPC) network. In other embodiments, the electronic device 2 may be a device that connects to network infrastructure over a radio interface, such as a mobile phone, smart phone or other such device that may be classified as a User Equipment (UE). In some embodiments, ED 102 may be a Machine Type Communications (MTC) device (also referred to as a machine-to-machine (m2m) device), or another such device that may be categorized as a UE despite not providing a direct service to a user. In some references, an ED 102 may also be referred to as a mobile device (MD), a term intended to reflect devices that connect to mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, etc. The electronic device 102 typically includes a processor 106, such as a Central Processing Unit (CPU), and may further include specialized processors such as a Graphics Processing Unit (GPU) or other such processor, a memory 108, a network interface 110 and a bus 112 to connect the components of ED 102. ED 102 may optionally also include components such as a mass storage device 114, a video adapter 116, and an I/O interface 118 (shown in dashed lines).

The memory 108 may comprise any type of non-transitory system memory, readable by the processor 106, such as static random-access memory (SRAM), dynamic random access memory (DRAM), synchronous DRAM (SDRAM), read-only memory (ROM), or a combination thereof. In specific embodiments, the memory 108 may include more than one type of memory, such as ROM for use at boot-up, and DRAM for program and data storage for use while executing programs. The bus 112 may be one or more of any type of several bus architectures including a memory bus or memory controller, a peripheral bus, or a video bus.

The electronic device 102 may also include one or more network interfaces 110, which may include at least one of a wired network interface and a wireless network interface. As illustrated in FIG. 1, network interface 110 may include a wired network interface to connect to a network 120, and also may include a radio access network interface 122 for connecting to other devices over a radio link. When ED 102 is network infrastructure, the radio access network interface 122 may be omitted for nodes or functions acting as elements of the Core Network (CN) other than those at the radio edge (e.g. an eNB). When ED 102 is infrastructure at the radio edge of a network, both wired and wireless network interfaces may be included. When ED 102 is a wirelessly connected device, such as a User Equipment, radio access network interface 122 may be present and it may be supplemented by other wireless interfaces such as WiFi network interfaces. The network interfaces 110 allow the electronic device 102 to communicate with remote entities such as those connected to network 120.

The mass storage 114 may comprise any type of non-transitory storage device configured to store data, programs, and other information and to make the data, programs, and other information accessible via the bus 112. The mass storage 114 may comprise, for example, one or more of a solid-state drive, hard disk drive, a magnetic disk drive, or an optical disk drive. In some embodiments, mass storage 114 may be remote to the electronic device 102 and accessible through use of a network interface such as interface 110. In the illustrated embodiment, mass storage 114 is distinct from memory 108 where it is included, and may generally perform storage tasks compatible with higher latency, but may generally provide lesser or no volatility. In some embodiments, mass storage 114 may be integrated with a memory 108 to form an heterogeneous memory.

The optional video adapter 116 and the I/O interface 118 (shown in dashed lines) provide interfaces to couple the electronic device 102 to external input and output devices. Examples of input and output devices include a display 124 coupled to the video adapter 116 and an I/O device 126 such as a touch-screen coupled to the I/O interface 118. Other devices may be coupled to the electronic device 102, and additional or fewer interfaces may be utilized. For example, a serial interface such as Universal Serial Bus (USB) (not shown) may be used to provide an interface for an external device. Those skilled in the art will appreciate that in embodiments in which ED 102 is part of a data center, I/O interface 118 and Video Adapter 116 may be virtualized and provided through network interface 110.

In some embodiments, electronic device 102 may be a standalone device, while in other embodiments electronic device 102 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

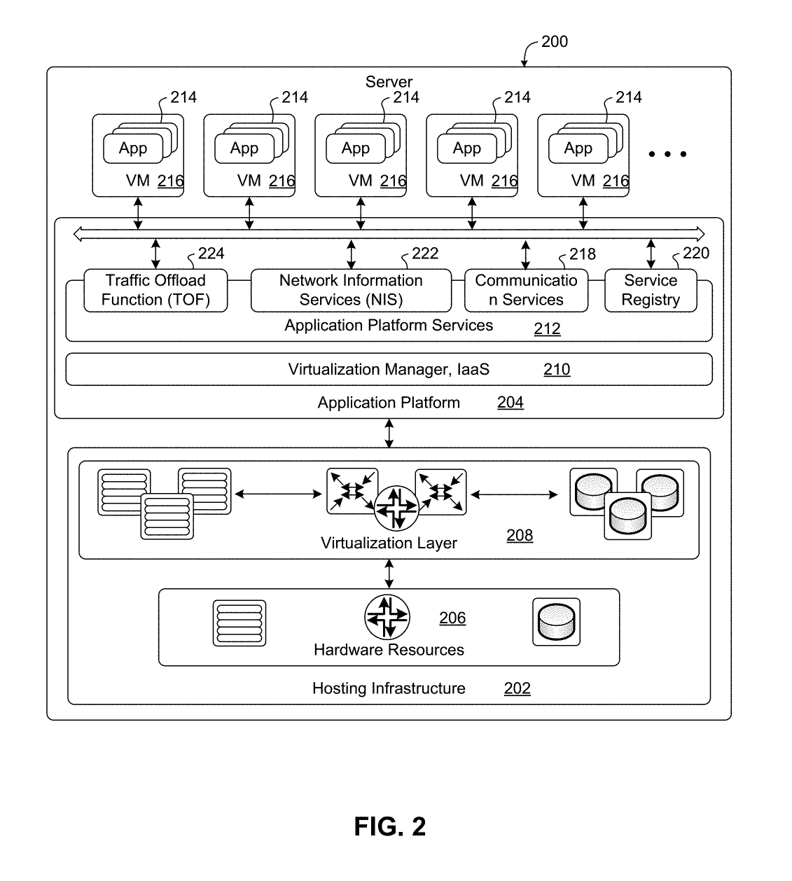

FIG. 2 is a block diagram schematically illustrating an architecture of a representative server 200 usable in embodiments of the present invention. It is contemplated that the server 200 may be physically implemented as one or more computers, storage devices and routers (any or all of which may be constructed in accordance with the system 100 described above with reference to FIG. 1) interconnected together to form a local network or cluster, and executing suitable software to perform its intended functions. Those of ordinary skill will recognize that there are many suitable combinations of hardware and software that may be used for the purposes of the present invention, which are either known in the art or may be developed in the future. For this reason, a figure showing the physical server hardware is not included in this specification. Rather, the block diagram of FIG. 2 shows a representative functional architecture of a server 200, it being understood that this functional architecture may be implemented using any suitable combination of hardware and software. It will also be understood that server 200 may itself be a virtualized entity. Because a virtualized entity has the same properties as a physical entity from the perspective of another node, both virtualized and physical computing platforms may serve as the underlying resource upon which virtualized functions are instantiated.

As may be seen in FIG. 2, the illustrated server 200 generally comprises a hosting infrastructure 202 and an application platform 204. The hosting infrastructure 202 comprises the physical hardware resources 206 (such as, for example, information processing, traffic forwarding and data storage resources) of the server 200, and a virtualization layer 208 that presents an abstraction of the hardware resources 206 to the Application Platform 204. The specific details of this abstraction will depend on the requirements of the applications being hosted by the Application layer (described below). Thus, for example, an application that provides traffic forwarding functions may be presented with an abstraction of the hardware resources 206 that simplifies the implementation of traffic forwarding policies in one or more routers. Similarly, an application that provides data storage functions may be presented with an abstraction of the hardware resources 206 that facilitates the storage and retrieval of data (for example using Lightweight Directory Access Protocol—LDAP). The virtualization layer 208 and the application platform 204 may be collectively referred to as a Hypervisor.

The application platform 204 provides the capabilities for hosting applications and includes a virtualization manager 210 and application platform services 212. The virtualization manager 210 supports a flexible and efficient multi-tenancy run-time and hosting environment for applications 214 by providing Infrastructure as a Service (IaaS) facilities. In operation, the virtualization manager 210 may provide a security and resource “sandbox” for each application being hosted by the platform 204. Each “sandbox” may be implemented as a Virtual Machine (VM) 216 that may include an appropriate operating system and controlled access to (virtualized) hardware resources 206 of the server 200. The application-platform services 212 provide a set of middleware application services and infrastructure services to the applications 214 hosted on the application platform 204, as will be described in greater detail below.

Applications 214 from vendors, service providers, and third-parties may be deployed and executed within a respective Virtual Machine 216. For example, MANagement and Orchestration (MANO) functions and Service Oriented Network Auto-Creation (SONAC) functions (or any of Software Defined Networking (SDN), Software Defined Topology (SDT), Software Defined Protocol (SDP) and Software Defined Resource Allocation (SDRA) controllers that may in some embodiments be incorporated into a SONAC controller) may be implemented by means of one or more applications 214 hosted on the application platform 204 as described above. Communication between applications 214 and services in the server 200 may conveniently be designed according to the principles of Service-Oriented Architecture (SOA) known in the art.

Communication services 218 may allow applications 214 hosted on a single server 200 to communicate with the application-platform services 212 (through pre-defined Application Programming Interfaces (APIs) for example) and with each other (for example through a service-specific API).

A service registry 220 may provide visibility of the services available on the server 200. In addition, the service registry 220 may present service availability (e.g. status of the service) together with the related interfaces and versions. This may be used by applications 214 to discover and locate the end-points for the services they require, and to publish their own service end-point for other applications to use.

Mobile-edge Computing allows cloud application services to be hosted alongside virtualized mobile network elements in data centers that are used for supporting the processing requirements of the Cloud-Radio Access Network (C-RAN). For example, eNodeB or gNB nodes may be virtualized as applications 214 executing in a VM 216. Network Information Services (NIS) 222 may provide applications 214 with low-level network information. For example, the information provided by NIS 222 may be used by an application 214 to calculate and present high-level and meaningful data such as: cell-ID, location of the subscriber, cell load and throughput guidance.

A Traffic Off-Load Function (TOF) service 224 may prioritize traffic, and route selected, policy-based, user-data streams to and from applications 214. The TOF service 224 may be supplied to applications 214 in various ways, including: A Pass-through mode where (either or both of uplink and downlink) traffic is passed to an application 214 which can monitor, modify or shape it and then send it back to the original Packet Data Network (PDN) connection (e.g. 3GPP bearer); and an End-point mode where the traffic is terminated by the application 214 which acts as a server.

As may be appreciated, the server architecture of FIG. 2 is an example of Platform Virtualization, in which each Virtual Machine 216 emulates a physical computer with its own operating system, and (virtualized) hardware resources of its host system. Software applications 214 executed on a virtual machine 216 are separated from the underlying hardware resources 206 (for example by the virtualization layer 208 and Application Platform 204). In general terms, a Virtual Machine 216 is instantiated as a client of a hypervisor (such as the virtualization layer 208 and application-platform 204) which presents an abstraction of the hardware resources 206 to the Virtual Machine 216.

Other virtualization technologies are known or may be developed in the future that may use a different functional architecture of the server 200. For example, Operating-System-Level virtualization is a virtualization technology in which the kernel of an operating system allows the existence of multiple isolated user-space instances, instead of just one. Such instances, which are sometimes called containers, virtualization engines (VEs) or jails (such as a “FreeBSD jail” or “chroot jail”), may emulate physical computers from the point of view of applications running in them. However, unlike virtual machines, each user space instance may directly access the hardware resources 206 of the host system, using the host systems kernel. In this arrangement, at least the virtualization layer 208 of FIG. 2 would not be needed by a user space instance. More broadly, it will be recognised that the functional architecture of a server 200 may vary depending on the choice of virtualisation technology and possibly different vendors of a specific virtualisation technology.

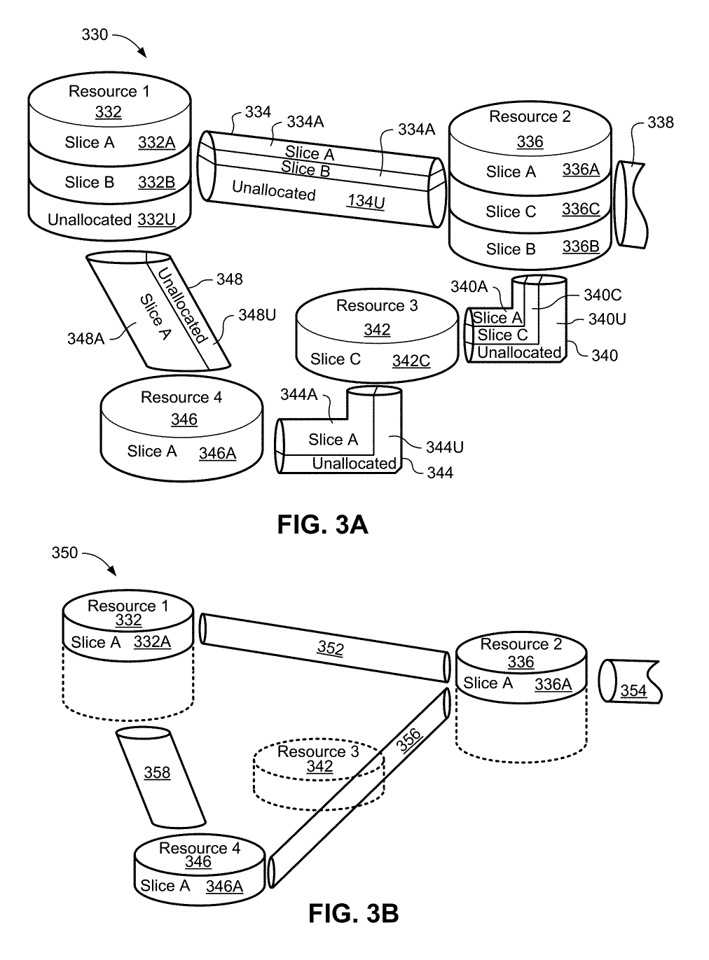

FIG. 3A illustrates an architecture 330 that connects a plurality of connectivity, compute and storage resources, and supports network slicing. In the following, resources are connected to other discrete resources through Connectivity Resources 334, 338, 340, 344 and 348. It will be understood that as network functions are instantiated within resources, they may be connected to each other by virtual connections that in some embodiments do not rely upon the physical connectivity resources illustrated, but instead may be connected to each other by virtual connections, which will also be considered as connectivity resources. Resource 1 332 is connected to Resource 2 336 by Connectivity Resource 334. Resource 2 336 is connected to unillustrated resources through Connectivity Resource 338, and is also connected to Resource 3 342 by Connectivity Resource 340. Resource 4 346 is connected to Resource 3 342 through Connectivity Resource 344, and to Resource 1 332 by Connectivity Resource 348. Resource 1 332, Resource 2 336, Resource 3 342 and Resource 4 346 should be understood as representing both compute and storage resources, although specialized functions may also be included. In some embodiments a specialized network function may be represented by any or all of Resource 1 332, Resource 2 336, Resource 3 342 and Resource 4 346, in which case, it may be the capability or capacity of the network function that is being sliced. Connectivity Resources 334, 338, 340, 344 and 1348 may be considered, for the following discussions, as logical links between two points (e.g. between two data centers) and may be based on set of physical connections.

Resource 1 332 is partitioned to allocate resources to Slice A 332A, and Slice B 332B. A portion 332U of the resources available to Resource 1 332 remains unallocated. Those skilled in the art will appreciate that upon allocation of the network resources to different slices, the allocated resources are isolated from each other. This isolation, both in the compute and storage resources, ensures that processes in one slice do not interact or interfere with the processes and functions of the other slices. This isolation can be extended to the connectivity resources as well. Connectivity Resource 334 is partitioned to provide connectivity to Slice A 334A and Slice B 334B, and also retains some unallocated bandwidth 334U. It should be understood that in any resource that either has unallocated resources or that has been partitioned to support a plurality of resources, the amount of the resource (e.g. the allocated bandwidth, memory, or number of processor cycles) can be varied or adjusted to allow changes to the capacity of each slice. In some embodiments, slices are able to support “breathing”, which allows the resources allocated to the slice to increase and decrease along with any of the available resources, the required resources, an anticipated resource need, or other such factors, alone or in combination with each other. In some embodiments the allocation of resources may be in the form of soft slices in which a fixed allocation is not committed and instead the amount of the resource provided may be flexible. In some embodiments, a soft allocation may allocate a percentage the resource to be provided over a given time window, for example 50% of the bandwidth of a connection over a time window. This may be accompanied by a minimum guaranteed allocation. Receiving a guarantee of 50% of the capacity of a connectivity resource at all times may provide very different service characteristics than receiving 50% of the capacity of the connectivity resource over a ten second window.

Resource 2 336 is partitioned to support allocations of the available compute and storage resources to Slice A 336A, Slice C 336C and Slice B 336B. Because there is no allocation of resources in connectivity resource 334 to Slice C, Resource 2 336 may, in some embodiments, not provide a network interface to Slice C 336C to interact with connectivity resource 334. Resource 2 336 can provide an interface to different slices to Connectivity Resource 338 in accordance with the slices supported by Connectivity Resource 338. Connectivity Resource 340 is allocated to Slice A 340A and Slice C 340C with some unallocated capacity 340U. Connectivity Resource 340 connects Resource 2 336 with Resource 3 342.

Resource 3 342 provides compute and storage resources that are allocated exclusively to Slice C 342C, and is also connected to Connectivity Resource 344 which in addition to the unallocated portion 344U includes an allocation of Connectivity Resource 344A to slice A. It should be noted that from the perspective of functions or processes within Slice A, Resource 3 342 may not be visible. Connectivity Resource 344 provides a connection between Resource 3 342 and Resource 4 346, whose resources are allocated entirely to Slice A 346A. Resource 4 346 is connected to Resource 1 332 by Connectivity Resource 348, which has a portion of the connection allocated to Slice A 348A, while the balance of the resources 348U are unallocated.

FIG. 3B illustrates the view of the architecture 336 of FIG. 3A as would be seen from the perspective of Slice A. This may be understood as a view of the resources allocated to Slice A 350 across the illustrated network segment. From within Slice A 350, only the portions of the resources that have been allocated to Slice A 350 are visible. Thus, instead of being able to see the full capacity and capability of Resource 1 332, the capabilities and capacity of the portion allocated to Slice A 332A is available. Similarly, instead of being able to see the capacity and capabilities of Resource 2 336, only the capabilities and capacity of the portion allocated to Slice A 336A are available. Because nothing from Resource 3 342 had been allocated to Slice A 350, Resource 3 342 is not present within the topology of Slice A 350. All of the capacity and capability of Resource 4 346 was allocated to Slice A 346, and as such is present within Slice A 350. Slice A 332A of Resource 1 332 is connected to Slice A 336A of Resource 2 336 by logical link 352. Logical Link 352 may correspond to the portion of connectivity resource 334 allocated to Slice A 334A. Slice A 336A is connected to logical link 354 (representative of the portion of connectivity resource 338 allocated to Slice A 350), and is connected to Slice A 346A by logical link 356. Logical link 356 is representative of the portions of connectivity resource 340 and connectivity resource 344 that have been allocated to Slice A (portions 340A and 344A respectively). It should be understood that due to the absence of Resource 3 342 from Slice A 150, any traffic transmitted by Slice A 336A onto Connectivity Resource 340A will be delivered to Resource 4 346, and similarly any traffic transmitted from Slice 346A into Connectivity Resource 344A will be delivered to Slice A 336A. As such, within Slice A 350, Connectivity Resources 340A and 344A can be modelled as a single logical link 356. Logical link 358 is representative of the portion of Connectivity Resource 348 allocated to slice A 348A.

It should be understood that within the storage and compute resources illustrated in FIGS. 3A and 3B, network functions can be instantiated using any of a number of known techniques, including network function virtualization (NFV), to create Virtual Network Functions (VNFs). While conventional telecommunications networks, including so-called Third Generation and Fourth Generation (3G/4G) networks, can be implemented using virtualized functions in their core networks, next generation networks, including so-called Fifth Generation (5G) networks, are expected to use NFV and other related technologies as fundamental building blocks in the design of a new Core Network (CN) and Radio Access Network (RAN). By using NFV, and technologies such as Software Defined Networking (SDN), functions in a CN can be instantiated at a location in the network that is determined based on the needs of the network. It should be understood that if a network slice is created, the allocation of resources at different data centers allows for the instantiation of a function at or near a particular geographic location, even within the slice where resources have been abstracted. This allows virtualized functions to be “close” in a physical sense to the location at which they are used. This may be useful, and may be combined with a sense of topological closeness to select a logical location at which to instantiate a function so that it is geographically or topologically close to a selected physical or network location.

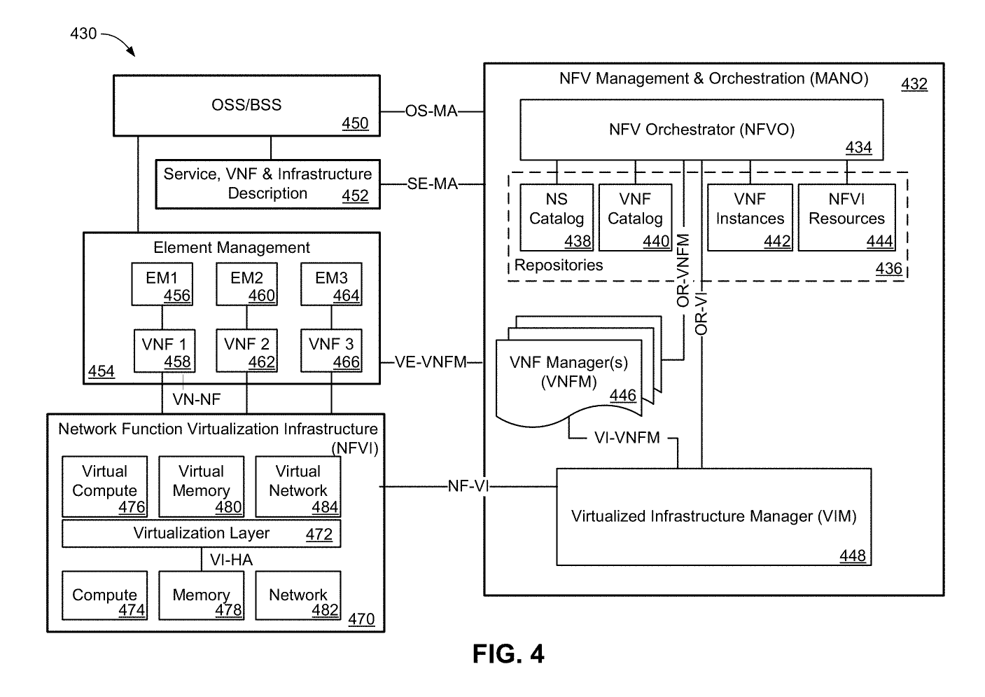

The European Telecommunications Standards Institute (ETSI) has developed a set of standards for Network Function Virtualization (NFV) MANagement and Orchestration (MANO). As illustrated in FIG. 4, the NFV-MANO system allows for the management of NFV instantiation and modification. As illustrated, there can be interfaces to existing systems such as the OSS/BSS. In network architecture 430, an NFV-MANO system 432 includes an orchestrator 434 which can access libraries 436 such as Network Service catalog 438, VNF Catalog 440, VNF Instances repository 442 and NFVI resources repository 444. The NS Catalog 438 may include templates which can be used as the basis for supporting network services. VNF catalog 440 may contain templates for the instantiation of different classes of VNFs. A particular VNF, after being instantiated, may be referred to as a VNF instance, and its attributes may be stored in VNF instances repository 442. NFVI resources 444 may be used to track the availability of resources, including both virtual resources and the physical infrastructure upon which they are instantiated. The NFVO 434 can be connected to a number of VNF Managers 446 through an OR-VNFM interface, and to a Virtualized Infrastructure Manager (VIM) 448 through a OR-VI interface. The VNFM 446 and VIM 448 can be connected to each other through a Vi-VNFM interface.

The NFV MANO 432 can communicate with an OSS/BSS system 450 through OS-MA interface, and to a Service, VNF & Infrastructure description database 452 though an SE-MA interface. The Service, VNF & Infrastructure description database 452 can contain operator information about the services, VNFs and infrastructure deployed in the network. Service, VNF & Infrastructure description database 452 and OSS/BSS 450 can be connected to each other so that the OSS/BSS 450 can update and maintain the Service, VNF & Infrastructure description database 452 as needed.

NFVI 470 interacts with the VIM 448 through the NF-VI interface. Underlying resources can often be classified as compute resources 474, memory resources 478 and network resources 482. Memory resources 478 may also be referred to as storage resources, while network resources 482 may also be referred to as connectivity resources. A virtualization layer 472 allows for the abstraction of the underlying resources which it is connected to through a Vi-HA interface. It should be understood that the underlying resources may be either physical or virtual resources. The Virtualization layer 472 allows for the abstraction of the underlying resources into virtual compute resources 476, virtual memory resources 480 and virtual network resources 484. These virtualized resources can be provided to the element management system 454 through the VN-NF interface so that they can be used as the resources upon which the VNFs (shown as VNF1 458, VNF2 462 and VNF 3 466) can be instantiated. EM 454 can be connected to the VNFM 446 within NFV MANO 432 through interface VE-VNFM, and to the OSS/BSS 450 through another interface. Each VNF instantiated upon the virtual resources provided by NFVI 470 can be associated with an element manager (EM1 456, EM2 460 and EM3 464). The use of an element manager allows the OSS/BSS to have two paths through which the VNFs can be managed. A VNF can be managed through the VNFM 446, or through the element manager associated with the VNF. Each element manager can provide the same management controls that it would otherwise provide for a physical network element. Thus, the OSS/BSS 450 can treat each VNF as a conventional network function. Modification to the resource allocation associated with a VNF can be requested by an element manager through the VNFM 446, or through a request from the OSS/BSS 450 over the OS-MA interface.

The virtualization of network functions allows functions to be deployed with the resources that are required. As the demand for the functions increases, the resources allocated to the functions can be increased, which avoids an intentional over provisioning of the functions at instantiation. In conjunction with the above described slicing and data center utilization, flexible networks can be deployed in a manner that allows an operator to dynamically modify the connectivity between functions (thus changing the logical topology of the network) and to dynamically modify the location of and resources allocated to the network functions (thus changing the physical topology of the underlying network). Additional resources at the same location can be allocated to existing function to allow for scaling up of an existing function, and resources can be removed from an allocation to allow for a scaling down of a function. Resources from more than one resource pool or data center can be allocated to a function so that it can be scaled out, and resources from different pools can be removed to allow a function to be scaled in. Functions can be moved by transferring their state information to another network function, and in some instances, a function can be moved through a combination of scaling out and scaling in functions.

3GPP Technical Reference (TR) 28.801 describes three functional entities for managing one or more NSIs to support communication services. These functional entities include a Communication Service Management Function (CSMF), a Network Slice Management Function (NSMF), and a Network Slice Subnet Management Function (NSSMF). The CSMF is responsible for translating the communication service related requirement to network slice related requirements. The CSMF communicates with Network Slice Management Function (NSMF). The NSMF is responsible for management and orchestration of NSI. The NSMF derives network slice subnet related requirements from network slice related requirements. The NSMF communicates with the Network Slice Subnet Management Function (NSSMF) and Communication Service Management Function. The NSSMF is responsible for management and orchestration of NSSI. The NSSMF communicates with the NSMF.

In addition, it is useful to consider an Infra-structure Management function (InMF) and a business service management (BSM) function. The Infra-structure Management function (InMF) may be considered to encompass one or more management entities associated with the provision of Infrastructure as a Service (IaaS). For example, the InMF may comprise one or part or all of the elements of the MAN 432 described above with reference to FIG. 4.

The BSM, also referred to as a Service Management (SM) function, may be responsible for service related management for one or more types of service. Specific BSM responsibilities may include: Service negotiation with a customer providing details of services that can be offered; finalizing the SLA and providing business service requirements to the appropriate management function. Example business service requirements may include the following. For a communication service, the BSM may send communications service requirements to CSMF. For NSI as a service, the BSM may send NSI requirements to NSMF. For NSSI as a service, the BSM may send NSSI requirements to NSSMF. For Infrastructure (or Assets) as a service, the BSM may send infrastructure requirements to InMF.

In some embodiments, the BSM may also provide service related information to the customer according to the negotiated SLA.

In the following text, headings in bold are provided as a useful guide to the reader but should not be considered limiting.

Involvement of the Management Functions when Providing Different Types of Business Services

There are four main business services considered in this disclosure: Communication service as a service (CaaS); NSI as a service (NSaaS); NSSI as a service (NSSaaS); and Infrastructure as a service (IaaS).

CSMF of a Communication Service Provider (CSP) may be configured to provide the communication service to the Communication Service Customer (CSC). NSMF of a Slice Provider may be configured to provide a network slice to the CSMF of the slice customer, which may be a network operator (NOP). NSSMF of a Subslice Provider may be configured to provide network subslice to the NSMF of a subslice customer, which may be a network operator (NOP). InMF of an Infrastructure Provider may be configured to provide network infrastructure to the NSSMF of an infrastructure customer, which may be a network operator (NOP).

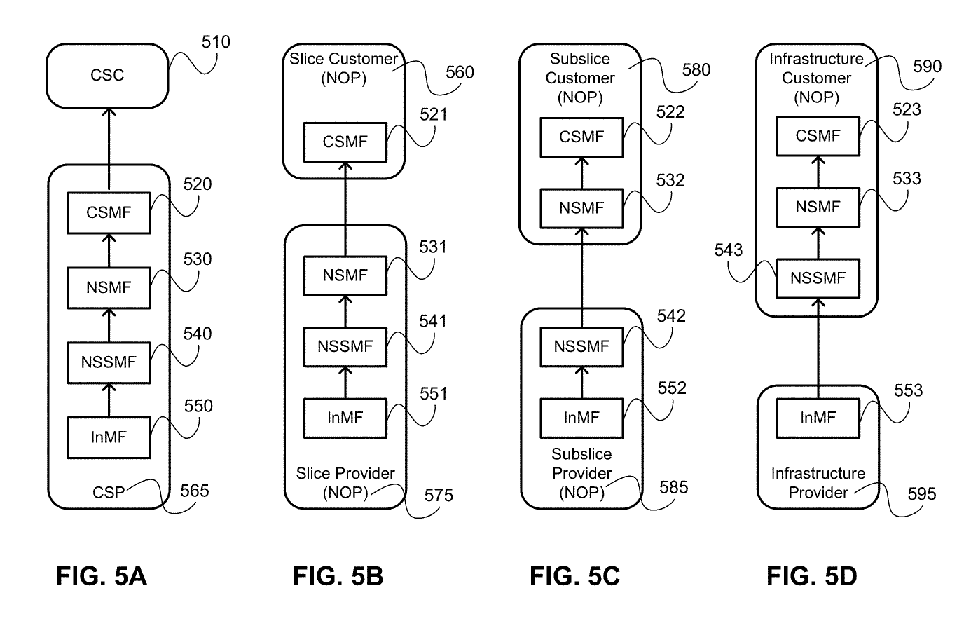

FIGS. 5A-5D illustrate example network management functions deployments for the four main type of telecommunication services according to embodiments, which are described in greater detail below. FIG. 5A illustrates providing a CSI as a service (CaaS); FIG. 5B illustrates providing an Network Slice Instance (NSI) as a service (NSaaS); FIG. 5C illustrates providing a Network Slice Subnet Instance (NSSI) as a service (NSSaaS); and FIG. 5D illustrates providing Infrastructure as a service (IaaS);

### Management Functions Involved in Providing a Communication Service

FIG. 5A illustrates an example network management function deployment for providing a communication service to a Communication Service Customer (CSC) 510, according to an embodiment. When the CSC 510 requires a communication service, the Communication Service Provider (CSP) 565 may use one or more network slices for the requested service and ensure that the E2E performance of the Communication Service instance (CSI) that is provided to the customer satisfies the terms of the negotiated SLA. Note that there can be multiple communication service instances served using a common Network Slice Instance (NSI). In the embodiment illustrated in FIG. 5A the CSP includes a CSMF 520, NSMF 530, NSSMF 540 and an InMF 550. This structure assumes the CSP can provide multiple service CSIs, using multiple NSIs, which in turn utilize multiple NSSIs, using infrastructure managed by the InMF 550. However, for embodiments in which the CSP 550 does not divide slices into multiple NSSIs, then there may be no NSSMF 540. Also, CSP can have multiple tenants, i.e., its management services and resources can be shared by multiple CSCs. From the aspect of intent-driven management, CSC indicates a higher-level, where less details about the network are known, compared to CSP. Therefore, CSP provides intent-driven networking services to CSC.

Business negotiation may be handled by the business and service management (BSM) entity and it finalizes the business service requirements and SLA. Then, the business requirements are processed to define a customer service requirement and provided to the CSMF. CSP can have tenant management and service management capabilities to handle negotiations. Alternatively, either one of these management capabilities can be at CSC, depending on the services and customers. CSP can utilize a high level of automation, management data analytics services, and intent-driven networking to process negotiations.

Intent-driven networking is a term used to describe when high-level requests can be made. For example, a customer may request a network operator provide a video service for 100 users. This request does not include any details regarding the network configuration etc. Alternatively, a more detailed request could be a request with configuration, policy and other details regarding network operation and creation, e.g., properties of network entities (deep packet inspector with X number of CPUs, Access and Mobility Management Function with Y capacity etc.), topology, policy etc. However, in order to enable the customer to make such a detailed request, the management capabilities, resource information etc. of the service provider need to be communicated (exposed) to the customer. Then, the customer can provide a detailed request, e.g., via filling the attributes of a network slice or service instance template.

Accordingly, a CSC making a request in business terms (e.g., a video service for 100 users) can be considered an example of intent-driven management. Intent-driven management can also apply for different types of network provider. For example, a CSMF requesting an NSI with high-level details, can also be considered another type/layer of intent-driven management. If the CSI provides all the details of a network slice instance request, then the intent can be considered “null”, as the CSI is not providing an intent, but all of the specific details of the NSI. Therefore, different exposure levels in this disclosure can correspond to different levels of intent-driven network management.

CSMF will provide the NSMF with network slice requirements that correspond to the service requirements. The communication service instance is the internal 3GPP representation of the service provided using the NSI.

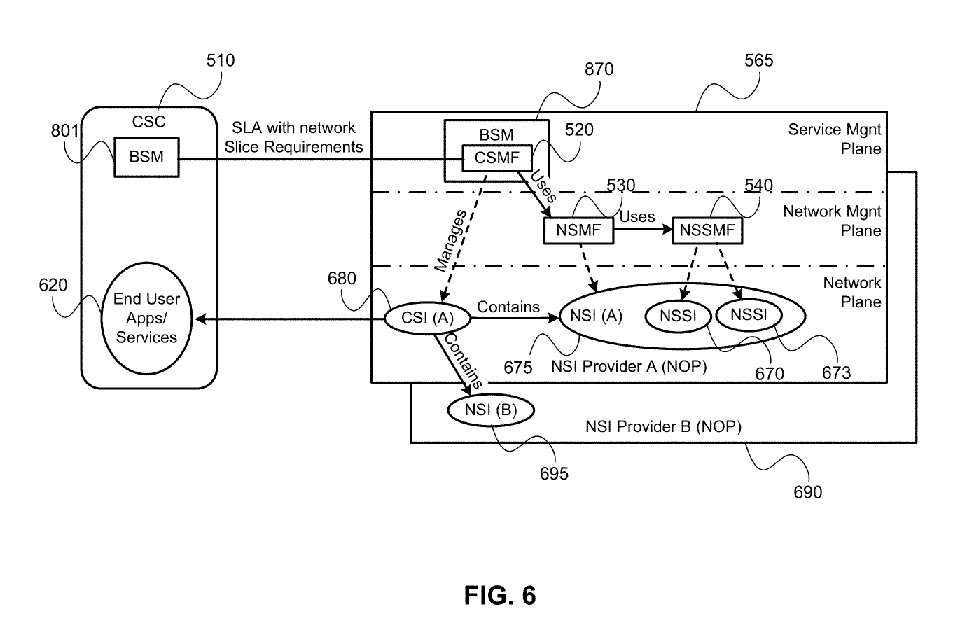

FIG. 6 shows an example deployment of management functions in providing a CSI as a service utilizing the deployment illustrated in FIG. 5A, according to an embodiment. In this case, the network slice management is hidden to the customer (CSC) 510. FIG. 6 illustrates the BSM 801 of a CSC 510 negotiating with the BSM 870 of a CSP, for example NSI provider 565 for CSI 680. CSI provider 565 includes a Service Management Plane (including BSM 870) a Network Management Plane (including NSMF 530 and NSSMF 540) and a network plane (including the CSI (A) which contains NSI A 675 (which may include NSSIs 670, 673). The BSM 870 includes CSMF 520 which uses the NSMF 530 (which in turn may use NSSMF 540) to create the NSI (A) 675. The CSMF 520 manages the CSI (A) 680, which contains the NSI (A) 675. In this context, CSI 680 is said to contain NSI A 675 as CSI 680 is implemented using NSI A 675. The BSM 870 negotiates with the BSM 801 of the CSC 510 to determine the SLA with network slice requirements, in order to provide CSI (A) 680 to the end user Apps/services 620 of the CSC 510. It should be appreciated that the CSP 565 of FIG. 5A and FIG. 6, could also be slice customer 560 of FIG. 5B. It is also noted that CSI 680 may also contain (i.e., utilize) NSI B 695 provided by a NSI B provider 690 if needed.

### Management Functions Involved in Providing NSI as a Service

In the embodiment illustrated in FIG. 5B a Slice customer 560 (which can act as an CSP 565 to CSC 510) includes a CSMF 521. Slice customer 560 utilizes one or more slices provided by a slice provider (NOP) 575. Slice provider 575 includes NSMF 531, NSSMF 541 and an InMF 551. This structure assumes NOP 575 can provide multiple service NSIs, using multiple NSSIs, using infrastructure managed by the InMF 551. However, for embodiments in which the NOP 551 does not divide slices into multiple NSSIs, then there may be no NSSMF 541.

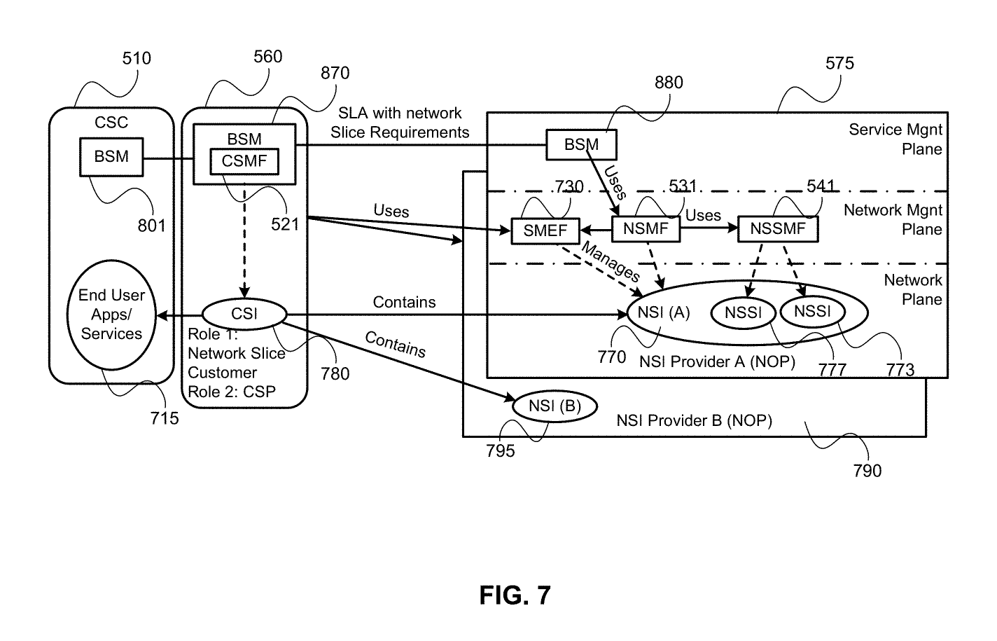

FIG. 7 shows and example deployment of management functions in providing an NSI as a service. In this case, the customer can be provided with limited network management capabilities by exposing certain management functions of the NSMF. This may be done through a Slice Management Exposure Function (SMEF) 730. It is noted that in FIG. 7, the slice customer (NOP) 560 is shown separate from CSC 510. In this model, the slice customer (NOP) 560 has two roles. First, NOP 560 acts as a network slice customer to a network slice provider (NOP) 575 (or 790). Second, NOP 560 acts as a CSP to CSC 510, providing CSI 780 to the end user apps/services 715 of CSC 510. However, it should be appreciated that the functionality of 560 and 510 can be combined and functions (such as BSM 801 and 870 can be integrated) in embodiments in which a single legal entity acts in both roles.

In some embodiments, the Slice Management Exposure Function (SMEF) 730 may act as an interface or a proxy to NSMF 531. The SMEF 730 manages the NSI 770, which may include NSSIs 777, 773, which are in turn created by NSSMF 541. The SMEF provides exposure interfaces for data and/or management exposure. It is the enabler to have different exposure levels without complicating individual network functions, such as NSMF, CSMF. An exposure level can be provided to the SMEF as an “intent”, and SMEF can arrange the network to respond to this intent/request. In this embodiment, SMEF 730 enables CSP 560 to monitor and/or manage NSI (A) 770 by exposing interfaces of NSMF 531. As a result, the CSP 560 obtains management capability without having the need to have the NSMF. The interface between SMEF 730 and CSP 560 can utilize intent-driven networking.

In some embodiments, how much is exposed is determined by the Network Operator (NOP) 575 and captured in the SLA since some of the management functionality may be handled by the NOP 575. For example, configuration management (CM) and fault management (FM) may be done by the Network Operator 575 and performance management (PM) may be done by the customer 560. This can lead to different automation levels, as well as, different levels of intent-driven management.

The service request and related service negotiation happens initially between the customer 510/560 using the CSMF 521 of BSM 870 interacting with BSM 880 of NSI Provider A 575, which is shown by a solid line. However, after the SLA is established by BSMs 870, 880, BSM 880 may provide network slice requirements to the NSMF 531 and NSMF 541. The network provider provides authorized access to certain NSMF functions so that the customer can use the NSI for its communication services. The interaction between BSMs 870, 880 can include requests and exposure for negotiating the SLA.

The network slice customer may use NSI A 770 and another NSI B 795 provided by a different Network Operator 790 to provide a communication service to a CSC. The CSMF 521 of the network slice customer 560 may prepare an integrated service instance 780 for this purpose, which uses both NSI A 770 and NSI B 795. It should be appreciated that the Slice provider 575 of FIG. 5B and FIG. 7, could also be slice customer 580 of FIG. 5C.

### Management Functions Involved in Providing NSSI as a Service

In the embodiment illustrated in FIG. 5C a Sub-Slice customer (which can act as an NOP to a slice customer) 580 includes a CSMF 522 and an NSMF 532. Sub-Slice customer 580 utilizes one or more slices provided by a sub-slice provider (NOP) 585. Sub-Slice provider 585 includes NSSMF 542 and an InMF 552. It is noted that in this specification, the terms sub-slice and subnet are used interchangeably.

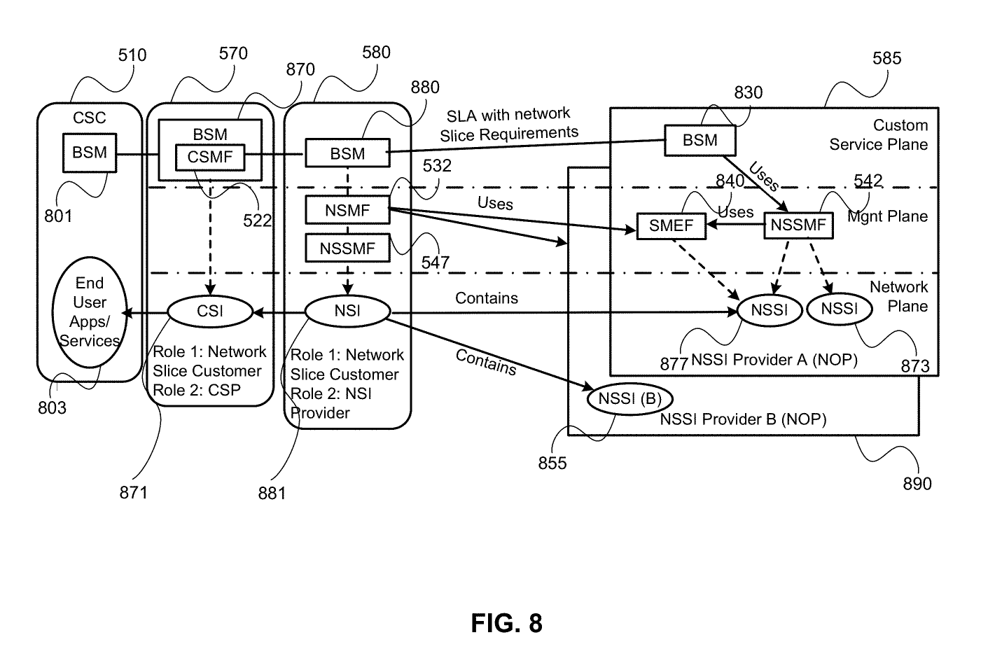

FIG. 8 shows a scenario having limited network management exposure to the customer's NSMF 532 or NSSMF 547 through SMEF 840 which may act as a proxy to NSSMF 542, according to an embodiment.

The service request and related service negotiation happens initially between the customer BSM 880 and the provider BSM 830 which is indicated by a solid line which indicates an SLA is established which meets network slice requirements. The BSM 830 may use NSSMF 542 to provide an NSSI 877,873 to the customer's NSMF 532 or NSSMF 547 as applicable. After the SLA is established, the network provider may provide authorized access to certain NSSMF functions so that the customer can use the NSSI for its communication purposes.

It is noted that in FIG. 8, the sub-slice customer (NOP) 580 is shown separate from the CSP 570 and the CSC 510. In this model, the sub-slice customer (NOP) 580 has two roles. First, NOP 580 acts as a network sub-slice customer to a network sub-slice provider (NOP) 585 (or 890). Second, NOP 580 acts as a NSI provider to CSP provider 570, providing NSI 881 to the CSP 570. Further, the slice customer (NOP) 570 has two roles. First, NOP 570 acts as a network slice customer to a network slice provider (NOP) 580. Second, NOP 570 acts as a CSP to CSC 510, providing CSI 871 to the CSC 510. In this model, the slice customer (NOP) 570 has two roles. First, NOP 570 acts as a network slice customer to a network slice provider (NOP) 575 (or 790). Second, NOP 570 acts as a CSP to CSC 510, providing CSI 780 to the end user apps/services 715 of CSC 510. However, it should be appreciated that the functionality of 580, 570 and/or 510 can be combined and functions (such as BSM 710 and 711 can be integrated) in embodiments in which a single legal entity acts as multiple roles. It should be appreciated that the Sub-Slice provider 585 of FIG. 5C and FIG. 8, could also be Infrastructure customer 590 of FIG. 5C.

### Management Functions Involved in Providing Infrastructure as a Service

In the embodiment illustrated in FIG. 5D an Infrastructure customer (which can act as an NOP to a slice or sub-slice customer) 590 includes a CSMF 523, NSMF 533 and (optionally) NSSMF 543. Infrastructure customer 590 utilizes infrastructure provided by InMF 553 of Infrastructure provider (NOP) 595.

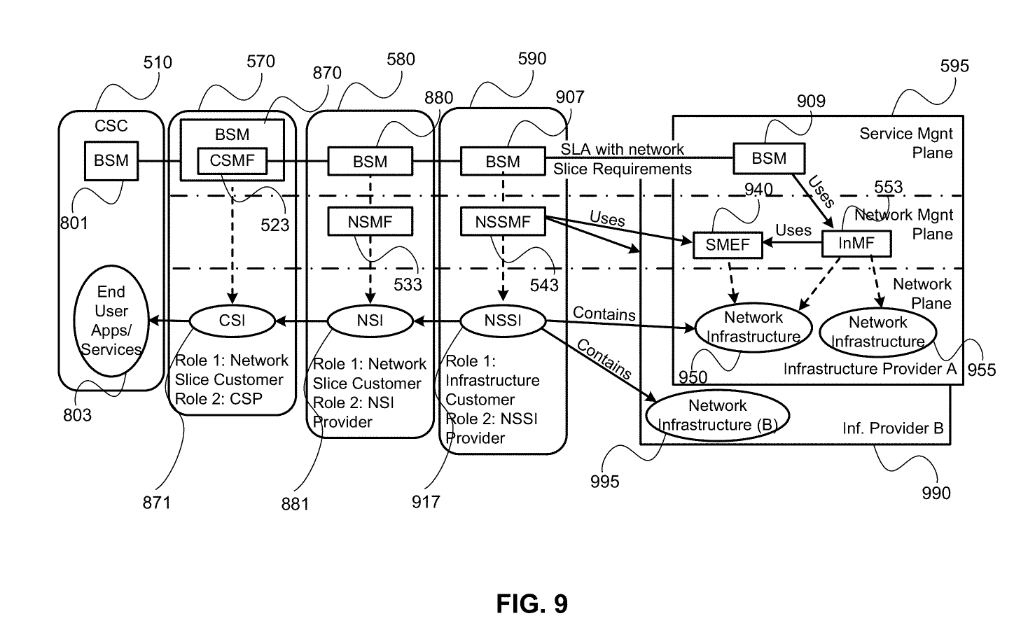

FIG. 9 shows a scenario having limited network management exposure to the customer's NSSMF 543 through SMEF 940 which may act as a proxy to NSSMF. In other words, via interfaces provided by the SMEF, NSSMF of the customer obtains management capability and information exposure towards the provided infrastructure. The SMEF provides exposure interfaces for data and/or management exposure. It is the enabler to have different exposure levels without complicating individual network functions, such as InMF, NSSMF. An exposure level can be provided to the SMEF as an “intent”, and SMEF can arrange the network to respond to this intent/request. In this embodiment, SMEF 940 enables 590 to monitor and/or manage network infrastructure 950 by exposing interfaces of InMF 553. As a result, the 590 obtains management capability without having the need to have the InMF. The interface between SMEF 730 and 590 can utilize intent-driven networking.

The service request and related service negotiation may happen initially between the customer BSM 907 and the provider BSM 909 which is indicated by a solid line. The BSM may use InMF 553 to provide network infrastructure (e.g., access node, links, virtual resources, network functions) to the customer's NSSMF 543 as applicable. After the SLA is established, the network provider may provide authorized access to certain InMF functions so that the customer can use the network infrastructure for its communication purposes. Similar to the above modes, the NSSI provider 590 servers multiple roles, namely the infrastructure customer to infrastructure providers 595, 990, and NSSI 917 provider to slice provider 580.

### Exposure Types and Openness Concepts

There are several exposure types based on exposure of information, management, and design capabilities:
A1: Fully closed—no exposure to clients or 3^{rd} parties
A2: Only service types (e.g., eMBB—HD video call, uRLLC—virtual reality, mIOT—meter reading) may be exposed to clients or 3^{rd} parties
B: Network slice templates with attribute list may be exposed to clients or 3^{rd} parties
C1: Network slice template and current/remaining network capacity as resource availability may be exposed to clients or 3^{rd} parties
C2: Network slice template and current/remaining network capacity, in terms of capability to provide specific service types, may be exposed to clients or 3^{rd} parties
D1: Abstracted view of the network or service capability may be exposed to clients or 3^{rd} parties
D2: All information may be exposed to clients or 3^{rd} parties
E1: All information and design capability may be exposed to 3^{rd} parties (preparation phase of NSI)
E2: All information, design and management capability (complete or partial lifecycle management of NSIs and NSSIs) may be exposed to 3^{rd} parties

Each exposure type includes a corresponding level of detail that can be provided in the request from a requesting customer. Accordingly, each exposure type allows for more detailed requests, allowing for more detailed control by the requester of the resources provided by the provider. From exposure type A1 to E2, the network management evolves from fully intent-driven to a less intent-driven fashion.

For all exposure types, the customer may be provided with monitoring information, e.g., alarms about reaching to congestion levels. In this context, exposure types may affect the procedures and contents in the interfaces. For example, in case of congestion, the customer may need to request and negotiate some modifications with the provider. If the customer has management capabilities, e.g. exposure type E2, the customer may be able to perform modifications to some extent. Similarly, if the customer provides NSTs, then, CSMF does not need to request database information from the NSMF.

Exposure types A to D enable a customer to make more clear offers, and more specific requests. The exposure types D1 and D2 enable the customer to interfere with the network. There are 2 main advantages of providing exposure to customers. One advantage provides quick service provisioning: e.g., the customer can prepare more detailed requests by being able to consider the capabilities of the network. A second advantage is flexibility: e.g, the customer has more flexibility to modify the services.

In terms of openness, the management entities may be closed, partially open or fully open to each other. For example, a CSMF may be provided with partial or full access the NSMF catalogue. The CSMF may not have the full access if the NSMF belongs to another vendor. In this case, CSMF may only send a common CST with attributes, or network requirements directly.

It is useful to distinguish between exposed information and exposed functions. For example, NST may be in a database, which is exposed. But the CSMF may have other capabilities and contents, such as vendor-specific algorithms and functions. Providing access to (i.e. exposing) NST does not imply that all of the CSMF is exposed. On the other hand, if management exposure is provided, e.g., exposure types E1&E2, then the CSMF of the provider may be bypassed by the CSMF of the customer, or it may be opened to the customer via an interface to facilitate exposure.

There are also other internal openness levels that are not listed in detail above, but are referred to when they are important for the procedures described in the following sections.

Table 1 below illustrates an example of exposure of management functions to a 3^{rd} party

| Use case stage | Evolution/Specification |
|---|---|
| Goal | To expose management functions of a communication service to a 3rd |
| | party with mutual agreement |
| Actors and | 3rd party customer (e.g., a vertical service provider as a CSC |
| Roles | (communication service customer), network slice consumer, network slice |
| | subnet consumer), network operator (e.g., CSP (communication service |
| | provider), network slice provider, network slice subnet provider) |
| Telecom | 3GPP management system |
| resources | |
| Assumptions | 1. Certain management functions can be exposed according to the pre- |
| | defined agreement (e.g., negotiation results) between 3rd party and the |
| | network operator. |
| | 2. Interface is available to set up the management exposure |
| | 3. The 3GPP management system is subscribed to receive change |
| | notifications. |
| Pre-conditions | 1. An NSI used for a customer's service is to be managed by the 3GPP |
| | management system and it is ready to provide the requested service to the |
| | 3rd party. |
| | 2. The 3GPP management system has received the management exposure |
| | request from the 3rd party. |
| Begins when | The 3GPP management system determines that requested management |
| | functions can be exposed to the 3rd party |
| Step 1 (M) | According to the pre-defined agreement, the 3GPP management system |
| | isolates those dedicated management functions that should be exposed to |
| | the 3rd party from other internal management functions. |
| Step 2 (M) | The 3GPP management system setups interfaces (e.g., API) for those |
| | dedicated management functions. |
| Step 3 (M) | The 3GPP management system exposes those interfaces to the 3rd party |
| Ends when | The 3rd party receives notification from the 3GPP management system |
| | that the management exposure set up is completed. |
| Exceptions | One of the steps identified above fails. |
| Post- | The 3rd party is able to manage certain functions of the 3GPP |
| conditions | management system associated with the requested service. |
| Traceability | |

Table 2 below illustrates an example of Exposure of communication service data to a 3^{rd} party

| Use case stage | Evolution/Specification |
|---|---|
| Goal | To expose data of a communication service in a mobile network to a 3rd party |
| | (e.g., CSC) with mutual agreement. |
| Actors and | 3rd party customer (e.g., a vertical service provider as a CSC, network slice |
| Roles | consumer, network slice subnet consumer) |
| | network operator (e.g., CSP, network slice provider, network slice subnet |
| | provider) |
| Telecom | 3GPP management system |
| resources | |
| Assumptions | 1. Certain data of the communication service can be exposed according to the |
| | pre-defined agreement (e.g., negotiation results) between 3rd party and the |
| | network operator. |
| | 2. Interface is available to set up the access of data. |
| Pre-conditions | 1. An NSI used for a customer's service is to be managed by the 3GPP |
| | management system and it is ready to provide the requested service to the 3rd |
| | party. |
| | 2. The 3GPP management system has received the data access request of the |
| | communication service from the 3rd party |
| Begins when | The 3GPP management system determines that the requested data of the |
| | communication service can be exposed to the 3rd party |
| Step 1 (M) | According to the pre-defined agreement, the 3GPP management system |
| | isolates those dedicated data from other service using the same NSI, NSSI or |
| | NFs. |
| Step 2 (M) | The 3GPP management system setups interfaces (e.g., API) for accessing |
| | those dedicated data. |
| Step 3 (M) | The 3GPP management system exposes those interfaces to the 3rd party |
| Ends when | The 3rd party receives notification from the 3GPP management system that |
| | the data of the communication service is ready to access. |
| Exceptions | One of the steps identified above fails. |
| Post- | The 3rd party is able to access the data of the communication service |
| conditions | |
| Traceability | |

### Procedure of Slice Provisioning

### Step-0 Procedures

These procedures are to perform initial network planning and service catalogue preparation. These may be common to all service types. A service provider network includes a Service Manager (SM) (also referred to as BSM).

Step 0-1: Infra-structure self-discovery and records preparation with access to the operator. This may include additional infrastructure that can be acquired/borrowed from 3rd parties.

Step 0-2; Operator decides what services to provide. For example, the operator can select the services to provide in cases in which there may be several options. For example. Operator may ask what services the network can support from SM (may use an automated SONAC tool which provides all the possible high level service types to the operator and the quantities that can be provided in each area). In other cases, the Operator may decide after analyzing the market trends.

Step 0-3: Operator provides policies (e.g. costs) for buying/selling/borrowing resources from 3rd parties

Step 0-4: Operator provides policies on service provision and provides service types that the network should provide (e.g. exposure).

Step 0-5: The Service Manager (SM) may prepare one or more service catalogues. Examples include: High level service types and attributes (details of 1st level categories); and High level service types and attributes with capacity for each service type for different geographical area (CaaS, NSaaS, NSSaaS).

### Network Slice Subnet as a Service (NSSaaS)

Network Slice Subnet as a Service (NSSaaS) can be provided in response to a new service request or to support an existing service (e.g. as a response to service update request). FIG. 8 illustrates management functions and managed objects involved in NSSaaS, according to an embodiment.

### Procedure for Service Negotiation

Step 1: Customer access the catalogue provided by the provider or the provider sends the available services to the customer depending on the exposure type and customer make a request to the provider. The NSSI request may have the following content depending on the exposure types.
Exposure A: The customer may directly query the provider, without knowing what are the available slice types (A1), or chooses a high-level slice type (A2) to prepare the request.
Exposure B: The customer may use the exposed NSSTs to prepare the request.
Exposure C: The customer may use exposed NSSTs and capacity information to provide the request.
Exposure D: The customer may use NSSTs, capacity information and other information available about the network, e.g. network functions (PNF, VNF), function chains etc. to prepare a detailed request.
Exposure E1 and E2: In E1, the customer may use all the information in D, and initiate the preparation phase of the NSSIs. In E2, customer's capabilities may be very similar to the provider's capabilities in Exposure A.

Step 2: SM of the provider receives customer requirements from the customer, which are the initial requirements. These requirements may include high-level service types, e.g., business service templates, isolation, security, charging methods, Geographical areas based time duration based network KPIs, management exposure types, and certain openness.

Step 3: SM performs an initial evaluation of the request and prepares initial internal service requirements. If the initial requirements are not feasible, e.g., exposure of information is not appropriate, the SM can re-negotiate. Also, if the requested service type is not provided by the NOP, a direct rejection of the request can also happen at this time. The SM may prepare internal service requirements to match the customer requirements for this purpose.
Exposure A: The SM prepares all the internal service requirements.
Exposure B to D: SM prepares the remaining internal service requirements.
Exposure E: Customer's SM may prepare most of the internal service requirements. SM finalizes requirement preparation.

Step 4: This procedure may trigger NSSaaS catalogue preparation, or NSSaaS catalogue update. A catalogue may be kept at database of NSSMF. In that case, NSMF and/or SM requests catalogue exposure (partially or fully open), or template list etc. The service catalogue update requires that a catalogue has been prepared prior to receiving the request for the current service.

Step 5: Feasibility check—VNAC has several steps and options as below after which the SM provide different options to the customer (counter-offers or acceptance of the request for an agreed cost).
Feasibility Option 1a for VNAC: SM has all the details of service capability for different service types obtained beforehand from CSMF, NSMF, NSSMF (for one of them or all of them) and check feasibility considering financial aspects. Financial aspects of the resources are obtained from BSS and evaluated (cost for the service, may be dynamically changed if customer agrees to that).
Feasibility Option 1b for VNAC: SM asks CSMF, NSMF or NSSMF about feasibility by providing service requirements or high level SLA details. They may come up with different service options for different resource costs. The design of the internal logical network may happen this time. But it may also be a high level feasibility check without the slice design.

Step 6: Re-negotiation and SLA preparation: Steps (2)-(5) may be repeated until an agreement is reached with the updated customer requirements. Financial aspects of the resources may be evaluated (e.g. cost for the service, which may be dynamically changed if customer agrees to that).

Step 7: If an SLA is not established, the NSSI request may be rejected.

Step 8: If an SLA is established, after agreeing to an SLA, internal requirement preparation may be finalized to create the logical network. The internal service requirement in NSSaaS in this case are the network slice subnet requirements which include NFs, NF chains, or high level capabilities

### Procedure for Preparing Internal Service Requirements

Customer's service request evaluation, feasibility check (VNAC) and SLA establishment are completed before this phase. The following procedure of internal service requirement (i.e., the network slice subnet requirement) preparation is performed at this stage. This is one of the phases of the service lifecycle:

Prepare Service Requirement—

SM sends the specific network requirements to NSSMF:
Exposure A: NSSMF may create a Network Slice Instance (NSST) using a template from the internal catalogue, or create a new one. In the case of Exposure type A2, NSMF or SM may map the type of service to one of the existing templates, or may create a new template for the service type, and then send it to NSSMF.
Exposure B-D: SM or NSMF sends the template provided by the customer to the NSSMF, which may include some attribute values for Exposure types C and D.
Exposure E: Customer NSSMF can bypass the provider NSSMF, or the NSSMF of the provider may be exposed to the customer via an exposure interface.
Alternatively, slice requirements can be send to NSSMF, and NSSMF can establish the required NSSTs and NSSIPs. In this case, the NSSMF may not be open to the NSMF and/or the SM, e.g., they may be provided by different vendors.
Note that, the NSSTs may be normally utilized when a new NSSI is created. However, the service requirements may consist of modifications to existing NSSIs.

### Service Deployment (NSSI Creation)

Prepared NSSIs are on-boarded in this stage
Exposure A-D: The Provider is responsible for full lifecycle (preparation, NSI provision, NSI run-time, NSI decommissioning) of the NSIs and NSSIs. NSMF performs this operation.
Exposure E1: The Customer can intervene in the preparation (including design, pre-provision, and network environment preparation (for only the exposed part of the network)) phase of the NSSI lifecycle. NSSMF may be exposed to the customer for this purpose.
Exposure E2: The Customer can intervene in with full lifecycle of the NSSIs.

NSSMF of the provider NSSaaS operation can begin after the deployment.
Exposure A-E1: Customer may receive acknowledgement indicating that the NSSI is activated.
Exposure E2: Customer may be directly involved in NSSI provision phase, which includes creation and activation. The customer may determine when to activate and on-board NSSI.
NSSMF of the provider may be bypassed or at least partially exposed, as desired.

### Service Operation (NSSI Run Time) Procedures

After an NSSI for a customer's NSI has been prepared and provisioned, the NSMF of the customer may request the activation of the NSSI so that NSSI's runtime begins.
Exposure A-E1: NSSaaS provider is responsible for monitoring and supervision of the service. The alerts are received, and responded to, by the NSSMF of the provider.
Exposure E2: NSSI lifecycle management is at least partially handled by the customer. The customer may utilize the NSSMF of the provider via an exposed interface, or utilize its own NSSMF. The alerts can be received, and responded to, by the customer.
Some modifications may be required on the service as a result of monitoring and supervision.

### NSSaaS Modification Procedures

Some modifications may be required while the NSSI is in run-time.
Exposure A-D: A request for modification can be negotiated with SM.
   Exposure A: The provider may design and perform required modifications. Feasibility of the modification request cannot be predicted by the customer.
   Exposure B: The customer may ask for specific values for some attributes. The feasibility of such a request cannot be predicted by the customer.
   Exposure C: The customer may ask for specific values for some attributes by considering the remaining capacity of the network (C1), and the capacity to provide what type of services (C2). The feasibility of the request can be predicted by the customer, but cannot be guaranteed.
   Exposure D: The customer can prepare a specific request by considering all the information, e.g., available capacity, functions (VNF, PNF), and their connectivity. The feasibility of the request can be predicted more accurately by the customer compared to Exposure C, but still cannot be guaranteed.
SM can perform/request a feasibility check as described above at Step (5). An update of the SLA may also be negotiated. The above steps are similar to steps (2)-(7) described above. If the requested modification is feasible, all the necessary steps (5)-(7) may be completed by the provider.

Service modification can trigger NSSI modification, termination, or creation of new NSSIs.
Exposure A-D: The lifecycle operations are performed by the provider's NSSMF. NSSMF may modify, de-activate, or terminate an existing NSSI, or create a new NSSI based on the accepted modification request.
Exposure E1: The above steps apply. In addition, if the required modification requires re-designing of the NSSI, the customer can be involved, for example, by determining VNFs and function chains via the exposed interface. However, the creation, activation, operation and termination of these NSSIs, functions etc. are performed by the provider's NSSMF. Negotiation for the request may be required if additional resources to what is already exposed is requested, or the proposed design cannot be provided.
Exposure E2: The customer can handle the NSSI modification, which may include creation, activation, operation and termination of the required NSSIs. The customer may not need negotiation, if the modification can be performed within the exposed network components.

### Service Termination (NSSI Deactivation or Decommissioning) Procedures

The customer's NSMF may request to terminate an NSSI. Optionally, the customer's SM may request this from the operator's SM and operator's SM may inform that to the NSSMF managing the NSSI.

The customer may send a request to the provider for service termination.
Exposure A-E1: The provider SM, CSMF, NSMF, and NSSMF may decide on whether to decommission the NSSIs, perform modification, or de-activate NSSI. This decision can be based on current and prospective services to utilize the NSSI.
Exposure E2: The customer may or may not perform decommissioning. The management exposure interface is disabled before the termination of the service.

NSSMF performs the required modifications to all NSSIs.

An acknowledgement may be received by the SM indicating that the NSSI decommissioning and/or modification is completed, required exposure interfaces are disabled, and NSSaaS is terminated.

SLA may be terminated upon receiving the acknowledgement.

### Network Slice as a Service (NSaaS)

Network Slice as a Service (NSaaS) can be provided in response to a new service request or to support an existing service (e.g. as a response to service update request). FIG. 7 illustrates management functions and managed objects involved in NSaaS.

### Procedure for Service Negotiation

Step 1: SM receives customer requirements from the customer, which are the initial requirements. These requirements may include high-level service types, e.g., business service templates, management exposure types, and certain openness.

Step 2; SM performs an initial evaluation of the request and prepares initial internal service requirements. If the initial requirements are not feasible, e.g., exposure of information is not appropriate, SM can re-negotiate. Also, if the requested service type is not provided by the NOP, a direct rejection of the request can be provided.

Step 3: Depending on the required exposure type, requested information may be provided to the customer, e.g., service types, catalogue, templates etc.
Exposure A: The customer directly inquiry the provider, without knowing what are the available slice types (exposure A1), or chooses a high-level slice type (exposure A2) to prepare the request.
Exposure B: The customer uses NSTs to prepare the request.
Exposure C: The customer uses exposed NSTs and capacity information to provide the request.
Exposure D: The customer uses NSTs, capacity information and other information available about the network, e.g. network functions, function chains etc. to prepare a detailed request.
Exposure E1 and E2: In E1, the customer uses all the information in D, and initiates the preparation phase of the NSIs. In E2, customer's capabilities are very similar to the provider's capabilities in Exposure A.

Step 4: SM may prepare internal service requirements to match the customer requirements for this purpose.
Exposure A: The SM prepares all the internal service requirements.
Exposure B to D: SM prepares the remaining service requirements.
Exposure E: Customer's SM may prepare most of the internal service requirements. SM finalizes requirement preparation.

Step 5: This procedure may trigger NSaaS catalogue preparation, or NSaaS catalogue update. A catalogue may be kept at database of NSMF. In that case, CSMF may request catalogue exposure (open), or template list etc. Similar request may be sent to NSSMF by NSMF.

Step 6: The service catalogue update requires an existing catalogue prepared earlier than receiving the request for the current service

Step 7: Feasibility check—VNAC has several steps and options:
Feasibility Option 1a for VNAC: SM has all the details of service capability for different service types obtained beforehand from CSMF, NSMF, NSSMF (for one of them or all of them) and check feasibility considering financial aspects, for example. Financial aspects of the resources may be obtained from BSS and evaluated (e.g. cost for the service, which may be dynamically changed if customer agrees to that).
Feasibility Option 1b for VNAC: SM asks CSMF, NSMF or NSSMF about feasibility by providing service requirements or high level SLA details. They may come up with different service options for different resource costs. In some embodiments, the design of the internal logical network may be performed at this time. In other embodiments, one a high level feasibility check without slice design may be performed.

Step 8: Re-negotiation and SLA preparation: If needed, steps (2)-(5) may be repeated until an agreement is reached with the updated customer requirements.

Step 9: If SLA is not established, the NSI is not provided.

### Procedure for Preparing Internal Service Requirements

Customer's service request evaluation, feasibility check (VNAC) and SLA establishment are completed before this phase. The following procedure of internal service requirement (i.e., the network slice requirement) preparation is performed at this stage. This is one of the phases of the service lifecycle:

Prepare service requirement—SM sends the specific network requirements to NSMF:
Exposure A: NSMF may create a Network Slice Instance (NST) using a template from the internal catalogue, or create a new one. If Exposure A2, CSMF or SM maps the type of service to one of the existing templates or creates a new template for the service type, and then sends it to NSMF.
Exposure B-D: SM or CSMF sends the template provided by the customer to NSMF, which may include some attribute values for Exposure C and D.
Exposure E: Customer NSMF can bypass the provider NSMF, or the NSMF of the provider is exposed to the customer via an exposure interface.

Alternatively, slice requirements can be sent to the NSMF, which can establish the required NSTs and NSIPs. In this case, NSMF may not be open to CSMF and/or SM, e.g., they may be provided by different vendors. An NST may include NSSTs. Details of NSS provisioning procedures are explained below.

An NSMF may communicate with an NSSMF to obtain or manage required NSSTs and NSSIPs. Alternatively, slice requirements can be sent to an NSSMF which can establish the required NSSTs and NSSIPs. In this case, NSSMF may not be open to NSMF, e.g., they may be provided by different vendors.

### Service Deployment (NSI Creation)

Prepared NSIs (and NSSIs) may be on-boarded in this phase.
Exposure A-D: Provider is responsible for full lifecycle (preparation, NSI provision, NSI run-time, NSI decommissioning) of the NSIs and NSSIs. NSMF performs this operation.
Exposure E1: Customer can be involved in the preparation (including design, pre-provision, network environment preparation (for only the exposed part of the network)) phase of the NSI lifecycle. NSMF may be exposed to the customer.
Exposure E2: Customer can be involved in full lifecycle of the NSIs and NSSIs. NSMF of the provider may be bypassed or exposed as desired.

NSMF of the provider of the NSaaS can begin operation after the deployment.
Exposure A-E1: Customer receives acknowledgement indicating that the slice is activated.
Exposure E2: Customer may be directly involved in NSI provision phase, which includes creation and activation. The customer can determine when to activate and on-board NSI.
The NSMF of the provider may be bypassed, or exposed, as desired.

### Service Operation (NSI Run Time) Procedures

After required NSIs for a customer's NSI request are prepared and provisioned, CSMF of the customer may request the activation of the NSI(s) so that NSIs runtime begins.
Exposure A-E1: NSaaS provider is responsible for monitoring and supervision of the service. The alerts are received and responded by the NSMF (and NSSMF) of the provider.
Exposure E2: NSI lifecycle management may be handled by the customer. The customer can utilize the NSMF of the provider via an exposed interface, or utilize its own NSMF. The alerts can be received, and responded to, by the customer.

Some modifications of the service may be required as a result of monitoring and supervision. NSaaS modification procedure is explained below.

### NSaaS Modification Procedures

Some modifications may be required while the NSI is in runtime.

Exposure A-D: A request for modification can be negotiated with SM.
Exposure A: The provider may design and performs the required modifications. The feasibility of requested modifications cannot be predicted by the customer.
Exposure B: The customer may ask for specific values for some attributes. The feasibility of requested modifications cannot be predicted by the customer.
Exposure C: The customer may ask for specific values for some attributes by considering the remaining capacity of the network, and the capacity to provide what type of services. The feasibility can be estimated by the customer, but cannot be guaranteed.
Exposure D: The customer can prepare a specific request by considering all the information, e.g., available capacity, functions (VNF, PNF), and their connectivity.

SM can perform/request a feasibility check (step 7 described above).
An update on the SLA may also be negotiated.
The above steps are similar to steps (2)-(7) described above. If the requested modification is feasible, and the necessary steps (5)-(7) are completed by the provider.

NSI modification can trigger NSSI modification, termination, or creation of NSSIs.
Exposure A-D: The lifecycle operations are performed by the provider's NSMF. NSMF may modify an existing NSI. NSMF may request NSSMF to perform modifications. NSSMF modification procedure is explained below.
Exposure E1: The above steps apply. In addition, if the required modification requires re-designing of the NSI and/or NSSI, the customer can be involved by e.g., determining VNFs and function chains via the exposed interface. However, the creation, activation, operation and termination of these NSSIs, functions etc. are performed by the provider's NSMF. Negotiation for the request may be required if additional resources to what is already exposed is requested, or the proposed design cannot be provided.
Exposure E2: The customer can handle the NSI modification, which may include creation, activation, operation and termination of the required NSSIs. The customer may not need negotiation, if the modification can be performed within the exposed network components.

### Service Termination (NSI Deactivation or Decommissioning) Procedures

The customer's CSMF or NSMF may request to terminate an NSI. Optionally customer's SM may request this from the operator's SM and operator's SM informs that to NSMF managing the NSI.

1. The customer may send a request to the provider for service termination.
Exposure A-E1: The provider SM, CSMF, NSMF, and NSSMF may decide on whether to decommission the NSSIs, perform modification, or de-activate NSI. This decision can be based on current and prospective services to utilize the NSI.
Exposure E2: The customer may or may not perform decommissioning. The management exposure interface is disabled before the termination of the service.

2. NSMF performs any required modifications to involved NSI and NSSIs (for example, via NSSMF).

3. An acknowledgement may be received by the SM indicating that the NSI decommissioning and/or modification is completed, required exposure interfaces are disabled, and NSaaS is terminated.

4. SLA may be terminated upon receiving the acknowledgement.

### Communication as a Service (CaaS)

Communication as a Service (CaaS) can be provided in response to a new service request or to support an existing service (e.g. as a response to service update request). FIG. 6 illustrates management functions and managed objects involved in CaaS.

### Procedure for Service Negotiation

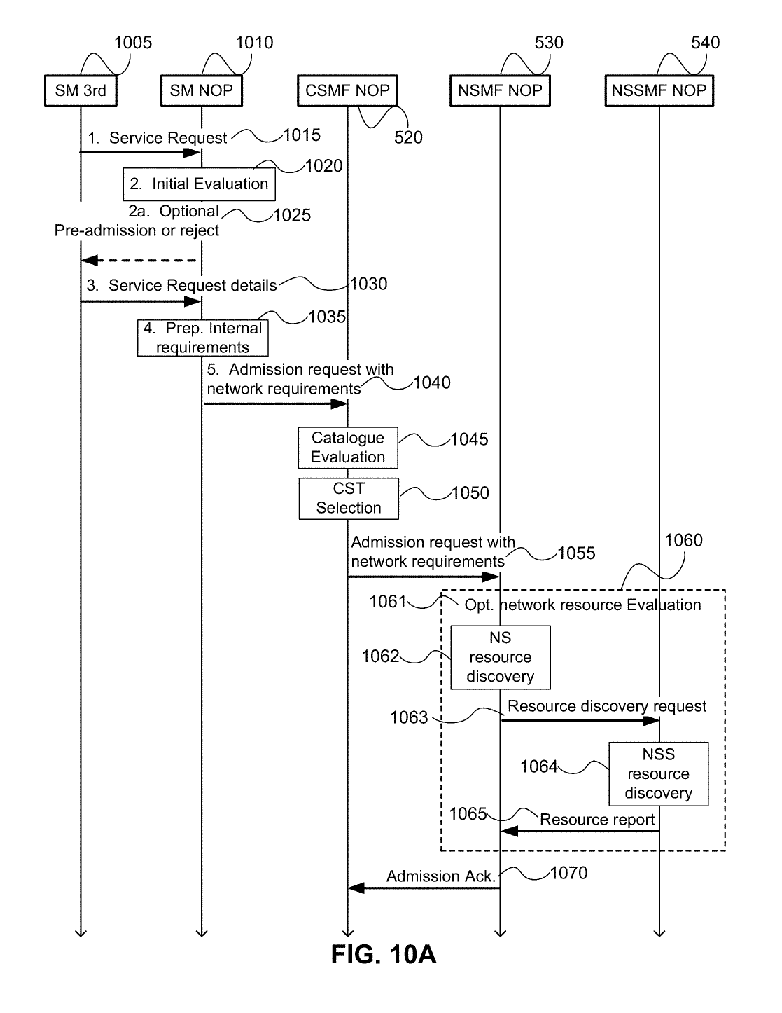

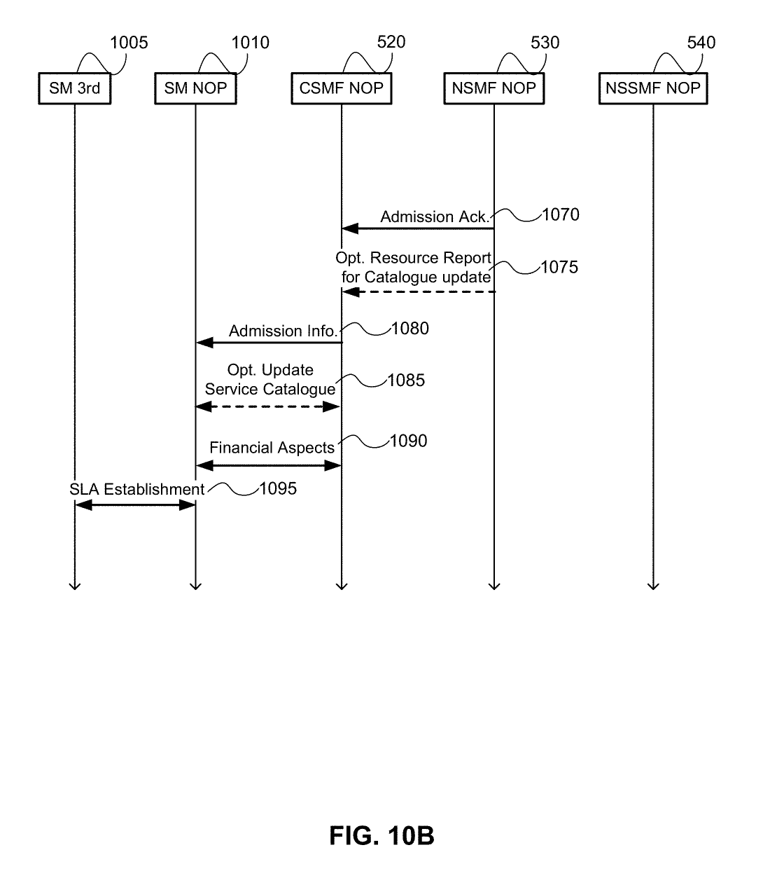

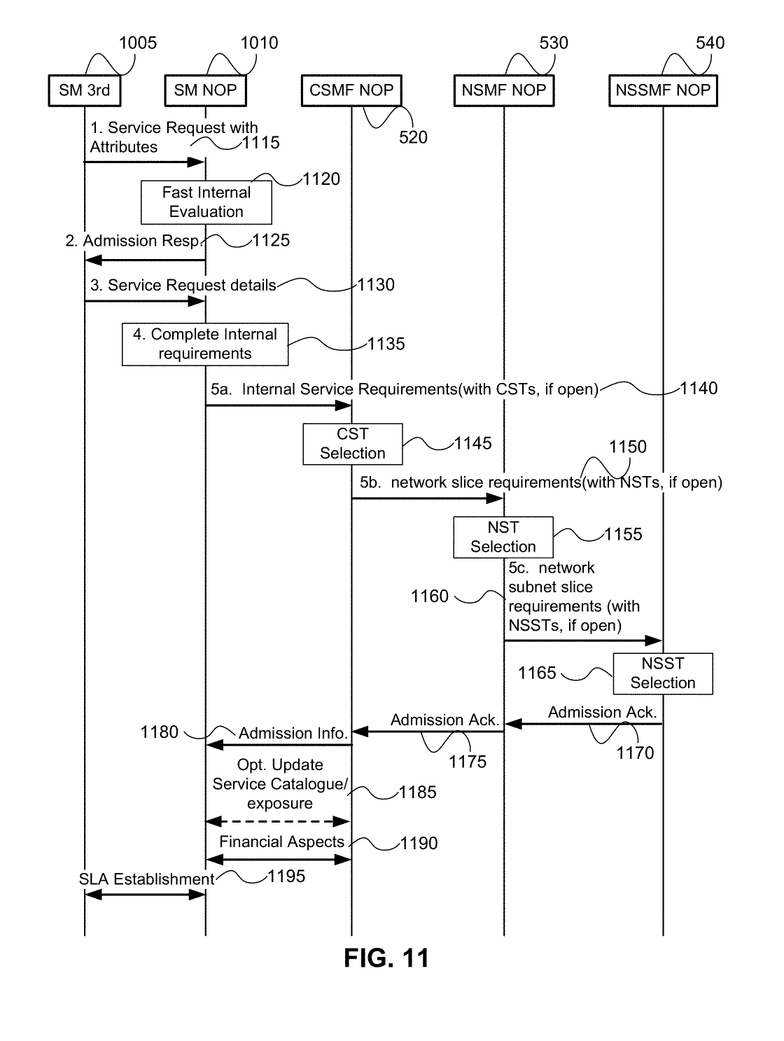

Step 1: Customer accesses the catalogue provided by the provider or the provider sends the available services to the customer depending on the exposure type and customer makes a request to the provider. The CSI request may have the following content depending on the exposure types. FIGS. 10 and 11 are call flow diagrams illustrating CaaS service negotiation for exposure type A (FIG. 10) and exposure types B-D (FIG. 11).
Exposure A: The customer may directly query the provider, without knowing what are the available slice types (exposure A1), or may choose a high-level slice type (exposure A2) to prepare the request.
Exposure B: The customer uses NSTs to prepare the request.
Exposure C: The customer uses exposed NSTs and capacity information to provide the request.
Exposure D: The customer uses NSTs, capacity information and other information available about the network, e.g. network functions, function chains etc. to prepare a detailed request.
Exposure E1 and E2: In E1, the customer uses all the information in D, and initiates the preparation phase of the NSIs. In E2, customer's capabilities are very similar to the provider's capabilities in Exposure A.

Step 2: SM of the provider receives customer requirements 1015 from the customer, which are the initial requirements. These requirements may include high-level service types, e.g., business service templates, isolation, security, charging methods, Geographical areas based time duration based network KPIs, management exposure types, and a requested level of openness.

Step 3: SM performs an initial evaluation of the request and prepares initial internal service requirements. If the initial requirements are not feasible, for example because a requested exposure of information is not appropriate, the SM can re-negotiate. Also, if the requested service type is not provided by the NOP, a direct rejection of the request can also happen at this time.

Step 4: SM may prepare internal service requirements to match the customer requirements.
Exposure A: The SM prepares all the internal service requirements.
Exposure B to D: SM prepares the remaining service requirements.
Exposure E: Customer's SM may prepare most of the internal service requirements. SM finalizes requirement preparation.

Step 5: The above procedure may trigger service catalogue preparation, or service catalogue update. The service catalogue update may require a catalogue to be prepared before receiving the request for the current service.

Step 6: Feasibility check—VNAC has several steps and options as below after which the SM provide different options to the customer (counter-offers or acceptance of the request for an agreed cost):
Feasibility Option 1a for VNAC: SM has all the details of service capability for different service types obtained beforehand from CSMF, NSMF, NSSMF (for one of them or all of them) and check feasibility considering financial aspects, for example. Financial aspects of the resources may be obtained from BSS and evaluated (e.g. cost for the service, which may be dynamically changed if customer agrees to that).
Feasibility Option 1b for VNAC: SM may query CSMF, NSMF or NSSMF about feasibility by providing service requirements or high level SLA details. They may respond with different service options for different resource costs. In some embodiments, the design of the internal logical network may happen this time. In other embodiments, a high level feasibility check may be performed without the slice design.

Step 7: Re-negotiation and SLA preparation: Steps (2)-(5) may be repeated until an agreement is reached with the updated customer requirements. Financial aspects of the resources may be evaluated.

Step 8: If an SLA is not established, the CSI is not provided.

### Procedure for Preparation of Internal Service Requirements

Customer's service request evaluation, feasibility check (VNAC) and SLA establishment are completed before this phase. The following procedure of internal service requirement (i.e., the network slice subnet requirement) preparation is performed at this stage. This is one of the phases of the service lifecycle:

Prepare service requirement—SM sends the specific network requirements to CSMF:
Exposure A: CSMF of the provider may create a Communication Slice Instance (CSI) using a template from the internal catalogue, or create a new one. If Exposure A2, the SM may map the type of service to an existing template or create a new template for the service type, and then send it to CSMF.
Exposure B-D: SM sends the template provided by the customer to CSMF, which may include some attribute values for Exposure C and D.
Exposure E: Customer CSMF can bypass the provider CSMF, or the CSMF of the provider may be exposed to the customer via an exposure interface.

CSMF can send NSI requirements to NSMF, which can establish the required NSTs and NSIPs. In this case, NSMF may not be open to CSMF, e.g., they may be provided by different vendors. An NST may include one or more NSSTs. Details of NSSI provisioning procedures are explained below.

NSMF may communicate with NSSMF to obtain or manage required NSSTs and NSSIPs. Alternatively, slice requirements can be sent to NSSMF, and NSSMF can establish the required NSSTs and NSSIPs. In this case, NSSMF may not be open to NSMF, e.g., they may be provided by different vendors.

Accordingly, an example call flow is illustrated in FIG. 10 (divided into FIGS. 10A and 10B for space reasons) for exposure type A, according to an embodiment. Accordingly the SM (e.g BSM) 1005 of the 3^{rd} party customer sends a service request 1015 to the SM (e.g, BSM) 1010 of the NOP. The SM 1010 performs an initial evaluation 1020, and optionally performs a pre-admission and exposes information 1025 (e.g., to enable the CSC to determine service request details in a more acceptable way, or to understand the reasons of rejection). Assuming not rejected, the SM 1005 then sends service request details 1030 to the SM of the NOP 1010. The SM 1010 prepares initial requirements 1035, and sends an admission request with network requirements 1040 to the CSMF 520 of the NOP. CSMF 520 performs catalog evaluation 1045, which may include selecting a communication service template (CST) 1050 that is suitable for service requirements, e.g., communication service type. CSMF 520 then sends an admission request (including network requirements) 1055 to the NSMF 530. An optional network resource evaluation occurs between NSMF 530 and NSSMF 540. NSMF 530 performs NS resource discovery 1062, and sends resource discovery request 1063 to NSSMF 540. NSSMF 540 performs NSS resource discovery 1064 and sends resource report 1065 to the NSMF 530 (note that the resource report may have different content based on the exposure level). The NSMF 530 sends an admission acknowledgment 1070 to the CSMF 520 (which is shown in both FIGS. 10A and 10B for the reader's convenience). The NSMF can optionally send a resource report 1075 to the CSMF 520, enabling a catalogue update. The CSMF 520 then sends the admission info 1080 to the SM 1010, which can optionally enable a service catalogue update 1085. It is noted that a double arrow is illustrated because this operation (1085) may contain some messaging between 1010 and 520. Financial aspects 1090 are exchanged and then the SLA is established 1095. The financial aspects 1090 of the resources are evaluated. The resource and cost information is available at CSMF. There can be several options to provide the service, e.g., cost for the service may be fixed or dynamically changed if customer agrees to that. These options are presented to the SM NOP to facilitate its negotiation with SM 3^{rd} to establish the SLA.

An example call flow is illustrated in FIG. 11 for exposure types B-D, according to an embodiment. Accordingly the SM (e.g BSM) 10051005 of the 3^{rd} party customer sends a service request with attributes 1115 to the SM (e.g, BSM) 1010 of the NOP. The SM 1010 performs an initial fast evaluation 1120, and sends an admission response which exposes information 1125. Assuming not rejected, the SM 10051005 then sends service request details 1130 to the SM 1010 of the NOP. The SM 1010 completes internal requirements 1135, and sends internal service requirements message 1140 to the CSMF 520 of the NOP. Message 1140 can include a listing of CSTs, if open. CSMF 520 performs CST selection 1145. CSMF 520 then sends network service requirements 1150 to the NSMF 530. Message 1150 can include a listing of NSTs, if open. NSMF 530 performs NST selection 1155, and can send network subnet slice requirements (with NSSTs if open) message 1160 to the NSSMF 540. NSSMF 540 then performs Network slice subnet template (NSST) selection. NSSMF 540 sends acknowledgement message 1170 to NSMF 530. The NSMF 530 sends an admission acknowledgment 1175 to the CSMF 520. CSMF 520 sends admission information 1180 to SM 1010, which can optionally enable a service catalogue update and exposure 1185. Financial aspects 1190 are exchanged and then the SLA is established 1195.

### Service Deployment (CSI Creation)

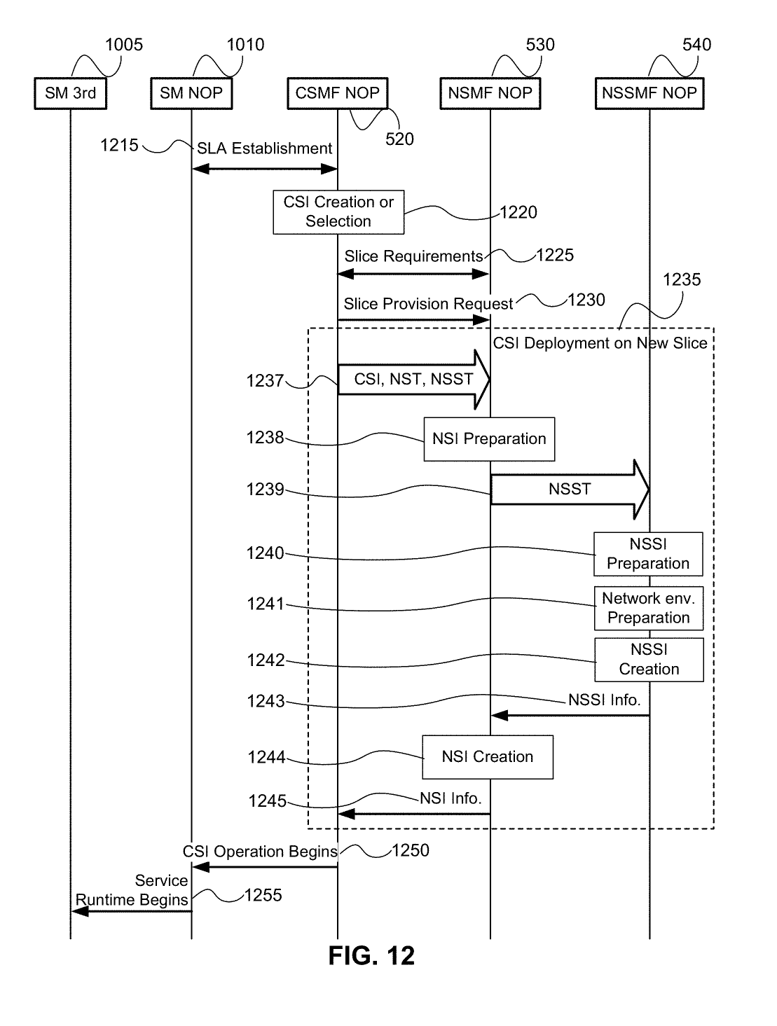

FIG. 12 is a call flow diagram illustrating an example of CSI deployment on a new slice with type A1 exposure to customer 1005, according to an embodiment. An SLA is established between the SM 1010 and the CSMF 520. A CSI is created or selected 1220. Slice requirements 1225 are exchanged between CSMF 520 and NSMF 530, resulting in CSMF 520 sending a slice provision request 1230 to NSMF 530.

If a new slice is necessary, the signalling for CSI deployment on a new slice is illustrated at 1235. The CSMF 520 sends the CSI, NST and NSST requirements 1237 to the NSMF 530. NSMF 530 performs NSI preparation 1238 and sends the NSST requirements 1239 to the NSSMF 540. The NSSMF 540 then performs NSSI preparation 1240, network environment preparation 1241 and NSSI creation 1242. The NSSMF 540 then transmits the NSSI information 1243 to the NSMF 530, which performs NSI creation 1244. The NSMF 530 then transmits the NSI information 1245 to the CSMF 520.

CSMF 520 informs the SM 1010 that CSI operation begins 1250. SM 1010 than informs the SM 1005 of the 3^{rd} party CSC 510 that Service runtime begins 1255.

Prepared CSIs are deployed in this stage.
Exposure A-D: CSMF of the provider is responsible for CSI deployment to NSI.
Exposure E1: Customer can be involved in the deployment phase of the CSI.
Exposure E2: Customer can be involved in the full lifecycle of the CSIs, and may also at least partially manage the related NSIs.

CSMF of the provider of CaaS can begin CaaS operation after this stage.
Exposure A-E1: Customer receives acknowledgement indicating that the CSI is activated.
Exposure E2: Customer is directly involved in CSI provision phase, which can include creation and activation. The customer can determine when to activate and on-board CSI.

### Service Operation (CSI Run Time) Procedures

After applicable NSIs for a customer's CSI are prepared and provisioned, the CSMF of the customer may request the activation of the CSI so that the CSI's runtime begins (except in Exposure E2, where the customer may not need to request activation).
Exposure A-D: Provider is responsible for full lifecycle (preparation, CSI provision, CSI run-time, CSI decommissioning) of the CSI, and the related NSIs and NSSIs. The CSMF monitors sand supervises life cycle management operations via NSMF.
Exposure E1: CSMF of the provider may be partially exposed to the customer for monitoring and supervision.
Exposure E2: Customer can be involved with full lifecycle of the CSIs. The CSMF of the provider may be at least partially exposed to the customer, or bypassed by the CSMF of the customer

Some modifications may be required on the service as a result of monitoring and supervision.

### CaaS Modification Procedures

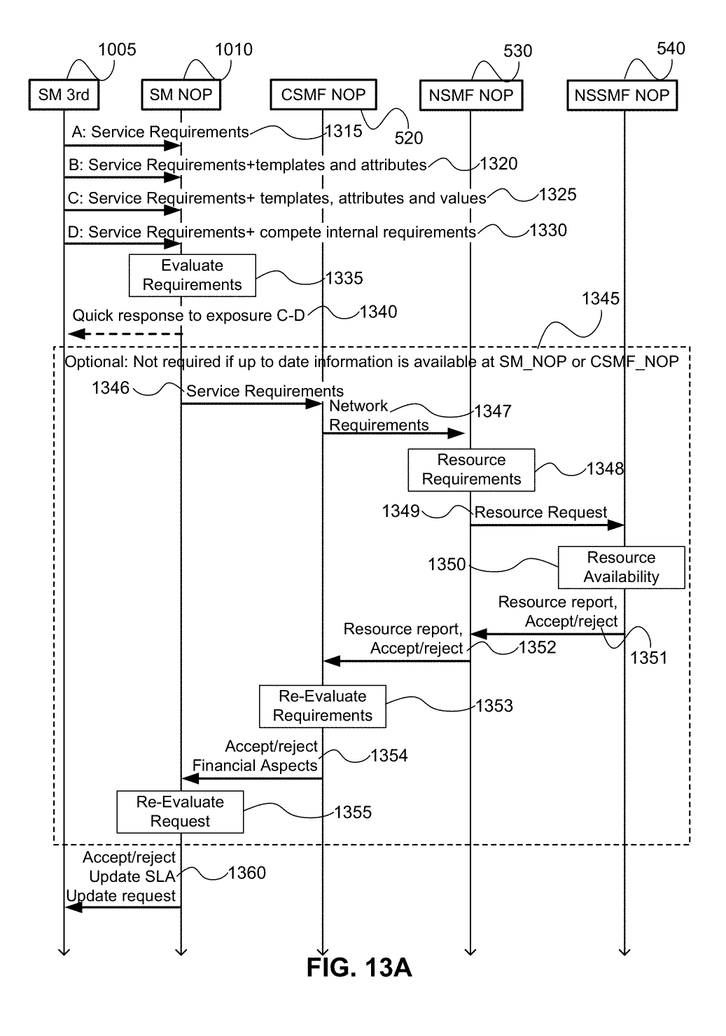

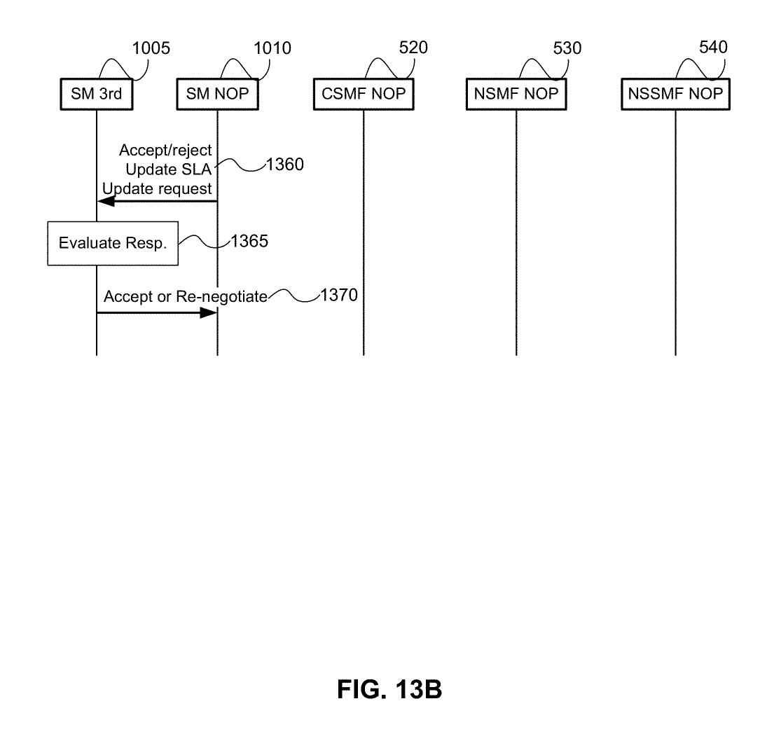

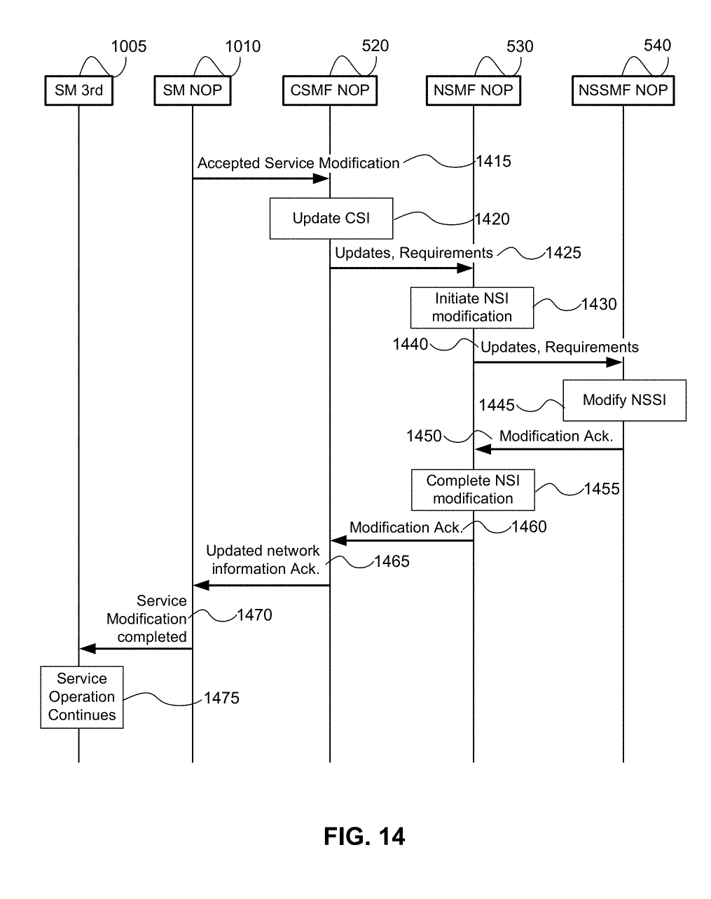

Some modifications may be required while the CSI is in run-time. FIGS. 13A and 13B show a call flow diagram illustrating an example of Service modification request negotiation for exposure types A-D. Note that the signalling shown in FIG. 13A may be repeated multiple times until an SLA is accepted. FIG. 14 is a call flow diagram illustrating an example of performing an accepted service modification request for exposure types A-D.
Exposure A-D: A request for modification can be negotiated with SM.
   Exposure A: The provider may design and perform the required modifications. The feasibility of the request cannot be estimated by the customer.
   Exposure B: The customer may ask for specific values for some attributes. The feasibility of the modification request cannot be estimated by the customer.
   Exposure C: The customer may ask for specific values for some attributes by considering the remaining capacity of the network (C1), and the capacity to provide what type of services (C2). The feasibility of the request can be estimated by the customer, but cannot be guaranteed.
   Exposure D: The customer can prepare a specific request by considering all the information, e.g., available capacity, functions (VNF, PNF), and their connectivity. The feasibility can be estimated more accurately by the customer compared to Exposure C, but still cannot be guaranteed.

SM can perform/request a feasibility check as described above. An update of the SLA may also be negotiated. The above steps are similar to steps (2)-(7) above. If the requested modification is feasible, all the necessary steps (5)-(7) are completed by the provider.

Service modification can trigger NS(S)I modification, termination, or creation of new NS(S)Is.
Exposure A-D: The lifecycle operations are performed by the provider's NS(S)MF. NS(S)MF may modify, de-activate, or terminate an existing NS(S)I, or create a new NS(S)I based on the accepted modification request.
Exposure E1: The above steps apply. In addition, if the required modification requires re-designing of the CSI, the customer can be involved via the exposed interface. However, the creation, activation, operation and termination of new NS(S)Is, functions etc. are performed by the provider's NS(S)MF with directions from provider's CSMF. Negotiation for the request may be required if additional resources to what is already exposed is requested, or the proposed design cannot be provided.
Exposure E2: The customer's CSMF can initiate the NS(S)I modification, which may include creation, activation, operation and termination of the required NS(S)Is via the exposed interface. The customer may not need negotiation, if the modification can be performed within the exposed network components.

### Service Termination (CSI Deactivation or Decommissioning) Procedure

The customer's CSMF may request to terminate the CSI. Optionally the customer's SM may request this from the operator's SM and operator's SM informs that to CSMF managing the CSI.

The customer may send a request to the provider for service termination.
Exposure A-E1: The provider SM, CSMF, NSMF, and NSSMF may decide on whether to decommission the related NSIs and NSSIs, perform modification on them, or de-activate them. This decision can be based on current and prospective services to utilize the prepared NSIs and NSSIs.
Exposure E2: The customer may or may not perform decommissioning. The management exposure interface is disabled before the termination of the service.

CSMF manages the required modifications with NSMF and NSSMF.

An acknowledgement may be received by the SM indicating that the CSI termination is completed, and required exposure interfaces are disabled. The SLA may be terminated upon receiving the acknowledgement.

Accordingly, FIG. 13A illustrates an example call flow for a modification according to an embodiment. Service requirements for the modification are transmitted from the SM 1005 of the 3^{rd} party CSC 510 to the SM 1010 of the CSP NOP. The level of the details included in the service requirement message corresponds to the Exposure type. For Exposure type A, just the service requirements 1315 are transmitted. For Exposure type B, message 1320 includes Service Requirements plus templates and attributes. For Exposure type C, message 1325 includes Service Requirements plus templates, attributes and values. For Exposure type D, message 1330 includes Service Requirements plus complete internal requirements.

For either type, the SM 1010 evaluates the requirements 1335, and can optionally send a quick response 1340 for exposure types C and D. A more detailed evaluation procedure 1345 may be needed if up to date information is not available at the SM 1010 or the CSMF 520. Such an evaluation includes the SM 1010 sending the service requirements 1346 to the CSMF 520. The CSMF 520 then sends the network requirements 1347 to the NSMF 530, which determines 1348 the resource requirements. The NSMF 530 sends a resource request 1349 to the NSSMF 540, which determines 1350 the resource availability. A resource report 1351, accepting or rejecting the modification, is sent from the NSSMF 540 to the NSMF 530. NSMF 530 then sends resource report 1352, accepting or rejecting the modification, to the CSMF 520. CSMF 520 then re-evaluates the requirements 1352, and then accepts or rejects the modification, along with sending financial aspects 1354 of the modification to the SM 1010. The SM 1010 then re-evaluates the request 1355 and accepts the request with an SLA update 1360 (or rejects the request).

Note that the signalling shown in FIG. 13A may be repeated multiple times until an SLA is accepted, as shown in FIG. 13B in which the SM 1005 receives the update/reject SLA message 1360, evaluates the response 1365, and either send an accept message or re-negotiation request 1370.

One a service modification is negotiated, resulting in an updated SLA, FIG. 14 provides an example of implementing the modification, according to an embodiment. FIG. 14 is a call flow diagram illustrating an example of performing an accepted service modification request for exposure types A-D. The SM 1010 informs CSMF 520 as to the accepted service modification 1415. The CSMF 520 updates the CSI 1420 and send updates (and any updated requirements) 1425 to the NSMF 530. The NSMF 530 performs NSI modification 1430 and send updates (and any updated requirements) 1440 to the NSSMF 540. NSSMF 540 modifies the NSSI 1445 and sends a modification acknowledgement 1450 to the NSMF 530, which completes the NSI modification 1455. The NSMF 530 sends a modification acknowledgement 1460 to the CSMF 520, which sends a modification acknowledgement 1465 (including updated network information) to the SM 1010. The SM 1010 then sends a service modification completed message 1470 to the SM 1005, and the modified service operation continues 1475.

### Infrastructure as a Service (IaaS)

Infrastructure as a Service (IaaS) can be provided to the customer to support an NSSI of the customer, as depicted in FIG. 9. As may be seen in FIG. 9, the Network operator (NOP), such as, for example, a service provider, can have an infrastructure management function (InMF). The InMF can be a separate entity, or can be a part of other management entities, or may comprise a combination of the functions of other management entities. InMF functions may access the infrastructure resource directly, or access other infrastructure managers, such as VIM (virtual infrastructure manager).

### Procedure for Service Negotiation

Step 1: SM receives customer requirements from the customer, which are the initial requirements. These requirements may include high-level service types, e.g., business service templates, management exposure types, and certain openness.

Step 2: SM performs an initial evaluation of the request and prepares initial internal service requirements. If the initial requirements are not feasible (for example, the exposure of information is not appropriate) the SM can re-negotiate. Also, if the requested service type is not provided by the NOP, a direct rejection of the request can be provided.

Step 3: Depending on the required information exposure type, requested information may be provided to the customer:
Exposure A: The customer may directly query the provider, without knowing what are the available infrastructure.
Exposure B: The customer can be provided with a generic list of available resources. Then, the customer can make an offer based on this exposed catalogue.
Exposure C: The catalogue of available resources, and their capabilities may be exposed to the customer. Then, the customer can make an offer based on the provided details.
Exposure D: The catalogue of available resources may be exposed to the customer with maximum detail. Then, the customer can make a precise offer based on the provided details.

Step 4: SM may prepare internal service requirements to match the customer requirements for this purpose.
Exposure A: The SM prepares all the internal service requirements.
Exposure B to D: SM prepares the remaining internal service requirements.

Step 5: This procedure may trigger IaaS catalogue preparation, or IaaS catalogue update. A catalogue may be maintained in a database of the SM.

Step 6: The service catalogue update requires an existing catalogue is prepared before receiving the request for the current service.

Step 7: Feasibility check—VNAC has several steps and options:
Feasibility Option 1a for VNAC: SM has all the details of service capability for different service types obtained beforehand from CSMF, NSMF, NSSMF (for one of them or all of them) and check feasibility considering financial aspects, for example. Financial aspects of the resources may be obtained from BSS and evaluated (cost for the service, may be dynamically changed if customer agrees to that).
Feasibility Option 1b for VNAC: SM asks CSMF, NSMF or NSSMF about feasibility by providing service requirements or high level SLA details. They may respond with different service options for different resource costs.

Step 8: Re-negotiation and SLA preparation: Steps (2)-(5) may be repeated until an agreement is reached with updated customer requirements. Financial aspects of the resources may be re-evaluated.

Step 9: If an SLA is not established, the IaaS is not provided.

Step 10: If an SLA is established, after agreeing to an SLA, internal requirement preparation is finalized to create the logical network.

Step 11: Management Exposure for IaaS:
Exposure E1: The customer can design the way the resources will be utilized, e.g., functions to be on-boarded. The InMF of the provider can be exposed to the customer. However, the provider is responsible for on-boarding, monitoring etc.
Exposure E2: The customer can fully control the provided resources. InMF of the provider may be fully exposed, or bypassed by the InMF of the customer.

### Procedure for Preparing Internal Service Requirements

IaaS requirements preparation, feasibility check (VNAC) and SLA establishment are completed before this phase. The following procedure is performed in relation to some service lifecycle phases:

1. Prepare service requirement—SM sends the specific network requirements to InMF:
Exposure E: These requirements may activate the requested exposure interface. Then, the rest of the service requirements (feasibility already checked by the SM in the steps before) can be sent to InMF of the provider directly.

### 4.6.4 Service Deployment (IaaS Creation) Procedures

Service Deployment—IaaS is ready to be deployed after internal preparation is completed.
Exposure E1: Customer can interfere provide the software for the functions to be on-boarded via the exposed interface. On-boarding etc. are performed by the InMF of the provider.
Exposure E2: Customer InMF can perform necessary actions for IaaS deployment, e.g., on-boarding functions.

Service Operation—IaaS operation can begin.
Customer receives acknowledgment that the all resources are prepared.

### Service Operation (IaaS Run Time) Procedures

After all resources are prepared and provisioned, IaaS runtime begins.
Exposure E1: Customer receives alerts, monitors, and supervises the operation of the InMF. Required modifications can be requested via the exposed interface, and performed by the InMF of the provider.
Exposure E2: Customer receives alerts, monitors, and supervises the operation of the InMF. Required modifications can be performed via the exposed interface.

Some modifications of the service may be required as a result of monitoring and supervision.

### IaaS Modification Procedures

Some modifications may be required while the IaaS is in run-time.

Exposure A-E1: A request for modification can be negotiated with SM.
Exposure A: The provider designs and performs the required modifications. The feasibility of the requested modification cannot be estimated by the customer.
Exposure B: The customer may ask for specific requests for some resources. The feasibility of the requested modification cannot be estimated by the customer.
Exposure C: The customer may ask for specific values for some resources by considering the remaining capacity of the resources (C1), and the capacity to provide what type of services (C2). The feasibility of the requested modification can be estimated by the customer, but cannot be guaranteed.
Exposure D: The customer can prepare a specific request by considering the detailed information. The feasibility of the requested modification can be estimated more accurately by the customer compared to Exposure C, but still cannot be guaranteed.

2. SM can perform/request a feasibility check. An update of the SLA may also be negotiated. The above steps are similar to steps (2)-(7) described above. If the requested modification is feasible, all the necessary steps (5)-(7) are completed by the provider.

3. Negotiation may be required for modification, if additional resources are required.

### Service Termination (IaaS Termination) Procedures

The customer may request to terminate IaaS.

1. The customer's SM may send a request to the provider's SM for service termination.
Exposure A-D: The Provider's SM is responsible for delivery of the termination request to the InMF. The InMF performs necessary termination operations, such as clearing memory, freeing resources, updating catalogue, or sending update information to NSSMF etc.
Exposure E1: The provider's SM or customer's InMF can deliver the termination request. The customer may perform some termination operations, such as controlling successful deletion of functions. Afterwards, the exposure interface is deactivated. Internal termination operations, e.g., catalogue updates, are performed by the provider's InMF.
Exposure E2: The provider's SM or customer's InMF can deliver the termination request. The customer may perform any termination operations, except internal operations, e.g., catalogue updates, are performed by the provider's InMF. Afterwards, the exposure interface is deactivated.

2. SM receives an acknowledgement indicating that the IaaS is terminated, all related resources are freed. SM may also receive updated catalogue information, or start a resource-discovery process.

3. SLA is terminated upon receiving the acknowledgement.

Network management entities carrying out or controlling the methods described above may be resident within a management plane of a communications network. These entities may interact with control plane entities (and possibly user/data plane entities) within the network slices instances that are created and discussed. These network management entities may provide methods and functions for the utilization of slice templates and slice instance profiles to satisfy or address (wholly or in part) communication service requests. These communication service requests may be received from a customer of a service provider. Addressing the communication service requests may include taking into account aspects of the lifecycle management of communication service instances and network slices instances.

An aspect of the disclosure provides a network architecture that can accommodate different types of service providers, each of which can be managed by different administrative domains. The SM is a management function (which can be part of a network management system) which handles the customer request, the specifics of which depends on the exposure level. Customer intent is passed to the SM and SM prepares the network requirement accordingly. In a fully exposed system, the SM does not have to do much as customer request includes most or all of the specifics for allocating the network resources to satisfy the service requirements. In other systems, the request merely specifies broad goals or intents, and it is up to the SM (in conjunction with other network functions) to allocate network resources to satisfy the intent/goals.

Accordingly, a first provider SM function receives a service request from a customer based on the exposed service information. The first provider provides the service using the information obtained from different management functions (which can be supplied by a 2nd provider). The first provider performs a feasibility check based on the information it has (either based on its own resources, and/or based on the 2nd provider's services). If information is not sufficient it can request information from the (2nd provider) other management functions. The information includes one or more of the service types the 2nd management function can provide, the current capacity of those services, the management capability that can be given to the 1st provider, the data that could be exposed to the 1st provider. Based on the feasibility check the 1st provider negotiate with the customer and set up the SLA.

An aspect of the disclosure provides a method of delivering a communication service. Such a method includes receiving, by a network management system, a request from a requestor for a service. The method further includes requesting, by the network management system, resources to satisfy the request. Such a method further includes receiving, by the network management system, information about the resources, and providing the service utilizing the resources. In some embodiments, receiving, by the network management system, information about the resources includes receiving information exposed by an external provider. In some embodiments, the method further includes responsive to receiving information about the resources, exposing details of the resources to the requestor; and negotiating, by the network management system, the parameters of the requested service with the requestor. In some embodiments, negotiating the parameters includes negotiating the parameters of a service agreement to provide the service. In some embodiments, the method further includes the management system exposes to the requestor interfaces for utilizing network functions associated with the service. In some embodiments, the method further includes providing access to network data pertaining to the requested service to the requestor using the interfaces. In some embodiments, the method further includes providing access to network functions for controlling the requested service to the requestor using the interfaces. In some embodiments, the method further includes reserving the resources exposed by the external provider. In some embodiments, requesting, by the network management system, resources to satisfy the request comprises evaluating internal resources and previously exposed resources from external providers to determine what further resources are needed to satisfy request and requesting the further resources. In some embodiments, the request is for a communication service, the requestor is a communication service customer service manager, the network management system includes a communication service provider service manager, and the external provider is a network slice provider which provides access to a network slice to the communication service provider service manager which in turn provides the requested communication service utilizing the network slice. In some embodiments, the request is for a communication service, the requestor is a communication service customer service manager, the network management system includes a Communication Service Management Function (CSMF), and the external provider is a Network Slice Management Function (NSMF) of a network slice provider which provides access to a network slice to the CSMF. In some embodiments, receiving, by the network management system, information about the resources comprises receiving information about the network functions of the network slice exposed to the CSMF from the NSMF. In some embodiments, the request is for a network slice, the requestor is a communication service provider service manager which requests access to a network slice, the network management system includes a Network Slice Management Function (NSMF) of a network slice provider; and the external provider is a Network Slice Subnet Management Function (NSSMF) of a network slice subnet provider. In some embodiments, the network management system can include an SM (BSM). In some embodiments the network management system can include an NSSMF or an InFM. In some embodiments, the request is for a network slice, the requestor is a service manager which requests access to a network subnet slice, the network management system includes a Network Subnet Slice Management Function (NSSMF) of a network sub-slice provider; and the external provider is an Infrastructure Management Function (InMF) of a Infrastructure provider. In some embodiments, the request is selected from a set of request categories, with each category in the set of request categories corresponding to an exposure level category of information exposed to the requestor provides exposure interfaces The method of claim 15 wherein each category provides additional exposure as to at least one of network data and network capability, such that additional details can be included in the request. In some embodiments, the service comprises a selected one of: Communication as a Service (CaaS), Network Slice as a Service (NSaaS), Network Slice Subnet as a Service (NSSaaS), and Infrastructure as a Service (IaaS). In some embodiments, the network management system includes a Service Management Exposure Function (SMEF) which provides exposure interfaces for providing the different categories of exposure. In some embodiments, the request includes partial attributes of at least one of a network slice template and a service instance template according to the exposure level category; and requesting, by the network management system, resources to satisfy the request includes requesting resources not specified in the request.

A further aspect of the disclosure provides a network management system including at least one network interface, a processor and machine readable memory storing machine readable instructions which when executed by the processor, implements a Slice Management Exposure Function. The SMEF is configured to expose interfaces to a 3^{rd} party requesting entity as to at least one of the management capability and data as to the resources controlled by the network management system.

Another aspect of the disclosure provides a network management system configured to selectively expose network management data; receive a request for a network service, the request including service requirements and parameters in accordance with the network management information to be exposed, wherein the service comprises a selected one of: Communication as a Service (CaaS), Network Slice as a Service (NSaaS), Network Slice Subnet as a Service (NSSaaS), and Infrastructure as a Service (IaaS); and responsive to the received request, negotiate a service level agreement based on the service requirements and parameters. In some embodiments the network management system is configured with management capability required for the service. In some embodiments, network management information to be exposed includes at least one of, the available Network slice template information, different service types and the available capacity information for those service types. In some embodiments the network management system is configured for accessing service and management data required for the service. In some embodiments the network management system is configured for accessing service and management data required for the service. In some embodiments the network management system is configured for at least one of: resource preparation for the service, life cycle management of the network used for the service.

In some embodiments the request has a specification detail corresponding to a network exposure type previously provided by the network provider. For example, there are several exposure types (A-D, E1 and E2) each with a different level of specificity as the management capabilities, resources and capacity. Accordingly, the request can have corresponding levels of specificity as to how to implement the request, from an intent based request as to the intent desired, to specific details of how to allocate previously exposed resources to deliver a requested service.

It is noted that that any of the network functions described herein, including the SM, BSM, CSMF, SMEF, NSMF, NSSMF, InFM etc., can be implemented using a suitably configured electronic device of FIG. 1 and/or server of FIG. 2.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method of delivering a communication service comprising:
receiving, by a network management system, a request from a requestor for a service;
requesting, by the network management system, resources to satisfy the request;
receiving, by the network management system, information about the resources; and
providing the service utilizing the resources.

2. The method of claim 1 wherein receiving, by the network management system, information about the resources comprises receiving information exposed by an external provider.

3. The method of claim 1 further comprising:
responsive to receiving information about the resources, exposing details of the resources to the requestor; and
negotiating, by the network management system, the parameters of the requested service with the requestor.

4. The method of claim 3 wherein negotiating the parameters comprises negotiating the parameters of a service agreement to provide the service.

5. The method of claim 4 further comprising the management system exposes to the requestor interfaces for utilizing network functions associated with the service.

6. The method of claim 5 further comprising providing access to network data pertaining to the requested service to the requestor using the interfaces.

7. The method of claim 5 further comprising providing access to network functions for controlling the requested service to the requestor using the interfaces.

8. The method of claim 2 further comprising reserving the resources exposed by the external provider.

9. The method of claim 2 wherein requesting, by the network management system, resources to satisfy the request comprises evaluating internal resources and previously exposed resources from external providers to determine what further resources are needed to satisfy request and requesting the further resources.

10. The method of claim 2 wherein the request is for a communication service, the requestor is a communication service customer service manager, the network management system includes a communication service provider service manager, and the external provider is a network slice provider which provides access to a network slice to the communication service provider service manager which in turn provides the requested communication service utilizing the network slice.

11. The method of claim 2 wherein the request is for a communication service, the requestor is a communication service customer service manager, the network management system includes a Communication Service Management Function (CSMF), and the external provider is a Network Slice Management Function (NSMF) of a network slice provider which provides access to a network slice to the CSMF.

12. The method of claim 11 wherein receiving, by the network management system, information about the resources comprises receiving information about the network functions of the network slice exposed to the CSMF from the NSMF.

13. The method of claim 2 wherein the request is for a network slice, the requestor is a communication service provider service manager which requests access to a network slice, the network management system includes a Network Slice Management Function (NSMF) of a network slice provider; and the external provider is a Network Slice Subnet Management Function (NSSMF) of a network slice subnet provider.

14. The method of claim 2 wherein the request is for a network slice, the requestor is a service manager which requests access to a network subnet slice, the network management system includes a Network Subnet Slice Management Function (NSSMF) of a network sub-slice provider; and the external provider is an Infrastructure Management Function (InMF) of a Infrastructure provider.

15. The method of claim 1 wherein the request is selected from a set of request categories, with each category in the set of request categories corresponding to an exposure level category of information exposed to the requestor provides exposure interfaces The method of claim 15 wherein each category provides additional exposure as to at least one of network data and network capability, such that additional details can be included in the request.

16. The method of claim 15 wherein the service comprises a selected one of: Communication as a Service (CaaS), Network Slice as a Service (NSaaS), Network Slice Subnet as a Service (NSSaaS), and Infrastructure as a Service (IaaS).

17. The method of claim 15 wherein the network management system includes a Service Management Exposure Function (SMEF) which provides exposure interfaces for providing the different categories of exposure.

18. The method of claim 15 wherein:
the request includes partial attributes of at least one of a network slice template and a service instance template according to the exposure level category; and
requesting, by the network management system, resources to satisfy the request includes requesting resources not specified in the request.

19. A network management system comprising:
at least one network interface;
a processor;
a machine readable memory storing machine readable instructions which when executed by the processor, implements a Slice Management Exposure Function configured to expose interfaces to a 3^{rd} party requesting entity as to at least one of the management capability and data as to the resources controlled by the network management system.

20. A network management system configured to:
selectively expose at least one of network management data and capability via an exposure function;
receive a request for a network service, the request including service requirements and parameters in accordance with the exposed network management data, wherein the service comprises a selected one of: Communication as a Service (CaaS), Network Slice as a Service (NSaaS), Network Slice Subnet as a Service (NSSaaS), and Infrastructure as a Service (IaaS); and
responsive to the received request, negotiate a service level agreement based on the service requirements and parameters.
